(19) United States
(12) Patent Application Publication
(10) Pub. No.: US 2026/0289085 A1
(43) Pub. Date: Sep. 24, 2026

(54) SYSTEM

(71) Applicant: SoftBank Group Corp., Tokyo (JP)

(72) Inventor: Hiroyuki YAMAUCHI, Tokyo (JP)

(73) Assignee: SoftBank Group Corp., Tokyo (JP)

(21) Appl. No.: 19/567,029

(22) Filed: Mar. 14, 2026

(30) Foreign Application Priority Data
Mar. 19, 2025 (JP) 2025-045229

(51) Int. Cl. G06F 40/166; G06F 40/103; G06F 40/284; G06N 3/0475

(52) U.S. Cl. CPC G06F 40/166; G06F 40/103; G06F 40/284; G06N 3/0475

(57) ABSTRACT

A system includes a processor that is configured to collect business data and generate a prompt that instructs a generative AI model to analyze the collected business data, input the generated prompt into the generative AI model to extract important information, and optimize a handover process and reduce a burden on a successor by using an emotion engine that recognizes a user's emotion.

### CROSS-REFERENCE TO RELATED APPLICATION

This application is based on and claims priority under 35 USC 119 from Japanese Patent Application No. 2025-045229 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

In conventional business environments, handover operations associated with retirement, personnel transfer, or role change are often performed manually and rely heavily on the implicit knowledge and subjective judgment of individual employees. As a result, important information embedded in large volumes of business data, such as work logs, documents, communications, and system records, is not systematically analyzed, and critical knowledge may be omitted or inadequately conveyed to successors. This can lead to loss of operational continuity, reduction of organizational productivity, and increased risk of human error during and after the handover process. Furthermore, conventional handover processes do not sufficiently consider the emotional state of users, such as anxiety and stress experienced by predecessors and successors, which can negatively affect the quality and efficiency of the handover. In particular, the burden on successors, who must rapidly understand complex tasks and organizational context, tends to be high, and existing systems do not provide adequate functions for reducing such burden while optimizing the handover process. Therefore, there is a need for a system that can utilize a generative AI model to automatically analyze collected business data, extract important information for handover, and additionally employ an emotion engine that recognizes user emotions to optimize the handover process and reduce the burden on successors.

### SUMMARY

In order to solve the above problems, according to one aspect of the present invention, there is provided a system comprising a processor, wherein the processor is configured to collect business data and generate a prompt that instructs a generative AI model to analyze the collected business data, input the generated prompt into the generative AI model to extract important information, and optimize a handover process and reduce a burden on a successor by using an emotion engine that recognizes a user's emotion. By causing the processor to collect business data relating to tasks, documents, communications, and operations, and to generate a prompt suitable for analysis by the generative AI model, the system enables automatic extraction of important information necessary for handover from large-scale and heterogeneous business data. Furthermore, by providing the emotion engine that recognizes the user's emotion and by causing the processor to optimize the handover process based on recognized emotional states, such as stress level, anxiety, or confidence of the user, the system can control the timing, amount, and presentation format of handover information, thereby reducing cognitive load and psychological burden on the successor. In addition, the processor may be configured to support handover operations in response to retirement or personnel transfer and to realize an effective handover in business operations within an organization, thereby improving operational continuity and overall efficiency of organizational handover processes.

The term “system” refers to an arrangement including at least one hardware device, such as a server, computer, or information processing apparatus, configured to execute one or more programs for performing the functions described in the present specification and claims. The term “processor” refers to a hardware processing unit, such as a central processing unit (CPU), graphics processing unit (GPU), dedicated accelerator, or a combination thereof, which executes instructions of a program to perform arithmetic operations, logical operations, control operations, and data processing associated with the functions described in the present specification and claims.

The term “business data” refers to data generated, stored, or used in the course of business operations, including but not limited to task records, project information, work logs, operation logs, documents, emails, messages, transaction records, and metadata related to such information.

The term “prompt” refers to a text, structured data, or other input content generated by the processor for the purpose of instructing a generative AI model regarding a processing objective, analysis target, output format, or constraints for analyzing the collected business data.

The term “generative AI model” refers to a machine learning model, such as a large language model or other generative model, trained on data to generate text or other structured outputs in response to an input prompt, and capable of performing analysis or transformation of business data as instructed by the prompt.

The term “important information” refers to information determined by the processor, based on analysis using the generative AI model, to be relevant or critical to business continuity or handover, including but not limited to key tasks, risks, decisions, dependencies, procedures, and knowledge necessary for a successor.

The term “emotion engine” refers to a software and/or hardware component configured to recognize or estimate a user's emotional state, based on input such as text, voice, physiological signals, interaction logs, or other behavioral data, and to output emotion-related parameters usable for optimizing the handover process.

The term “user's emotion” refers to an emotional state of a user, including but not limited to stress, anxiety, confidence, satisfaction, frustration, or other affective conditions, which is recognized or estimated by the emotion engine.

The term “handover process” refers to a series of operations by which information, responsibilities, tasks, and knowledge relating to business operations are transferred from a predecessor to a successor, including preparation, explanation, documentation, confirmation, and follow-up support.

The term “successor” refers to a user who assumes responsibilities, tasks, or roles previously performed by another user, and who receives information and support in the handover process.

The term “burden on a successor” refers to cognitive load, time load, or psychological load experienced by the successor in understanding, assuming, and executing handed-over tasks and responsibilities, including effort required to interpret, organize, and apply handover information.

The term “retirement” refers to a situation in which a user permanently leaves an organization or employment position, thereby triggering a need for handover of tasks and responsibilities to another person.

The term “personnel transfer” refers to a situation in which a user changes position, department, or role within an organization, thereby requiring reassignment and handover of some or all of the user's tasks and responsibilities to a successor.

The term “business operations within an organization” refers to activities, tasks, processes, and workflows carried out by members of an organization to achieve organizational objectives, including management, development, production, sales, support, and administrative functions.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

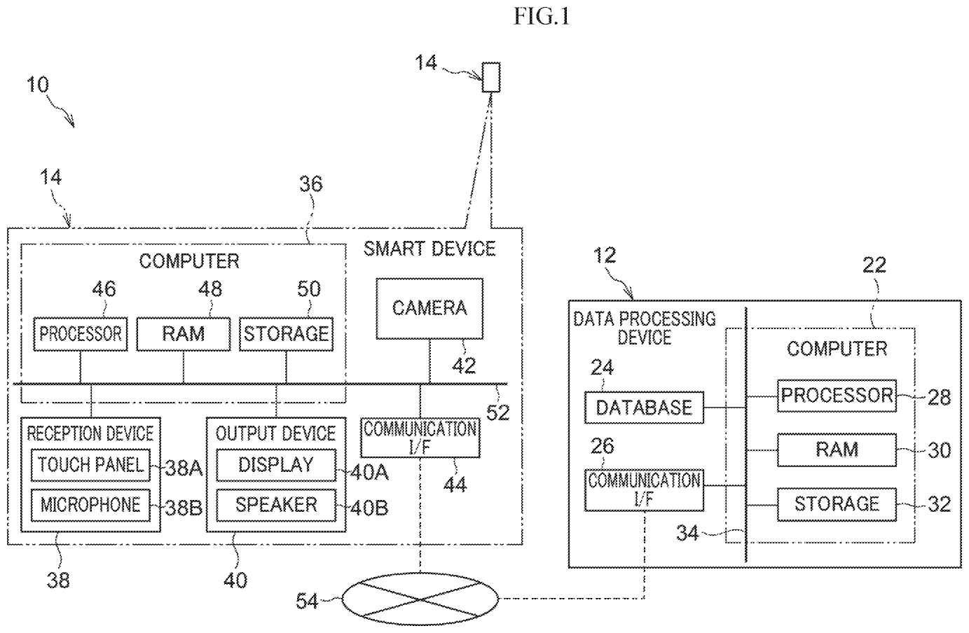

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

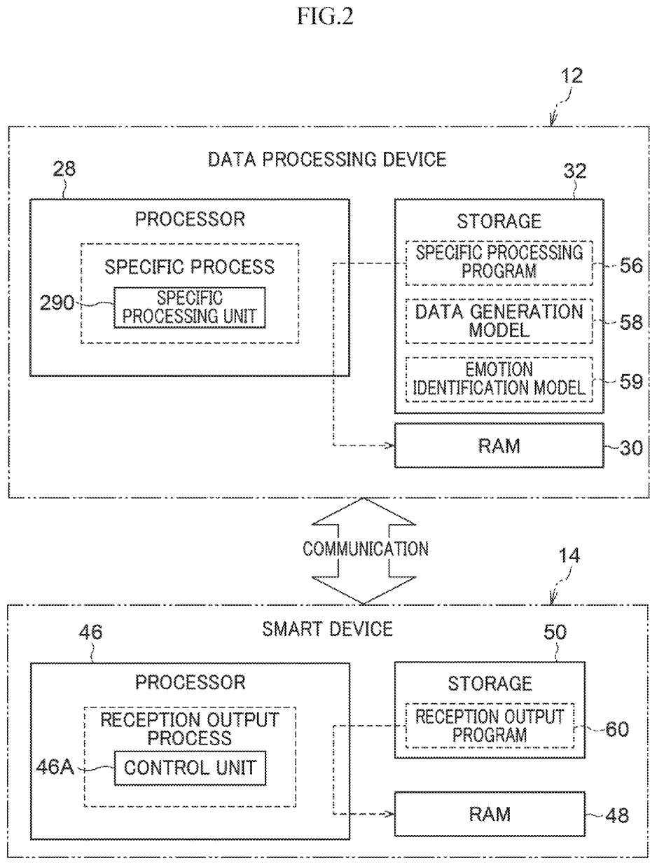

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional business handover support techniques largely rely on static document templates, manual summarization, and simple rule-based systems. These approaches require a user to manually select, filter, and organize past business information, which is labor-intensive and error-prone. Moreover, existing systems typically do not leverage a generative AI model with explicitly constructed prompt sentences that are dynamically adapted based on actual data usage and user feedback. As a result, conventional systems fail to consistently extract the most relevant information for handover, and they do not improve their behavior over time in a data-driven manner.

From a computer-technology perspective, typical systems lack an integrated processing pipeline that (i) normalizes heterogeneous business data into a machine-tractable format, (ii) structures the data into categories specifically optimized for a generative AI model input, (iii) generates and refines a prompt sentence that controls the generative AI model behavior, and (iv) automatically validates and restructures the model output into domain-specific, queryable handover information. Without such an integrated pipeline, a processor cannot efficiently orchestrate data ingestion, AI inference, feedback capture, and iterative adaptation of both pre-processing and post-processing logic, and system performance in terms of accuracy, robustness, and maintainability remains limited.

In addition, known systems do not tightly couple user-side interaction including corrections and qualitative evaluations with internal model-orchestration logic. Feedback, when collected, is typically stored as free-form text that is not systematically associated with the original input data and model output. This prevents the processor from using the feedback as structured training or configuration data for improving the generative AI model prompts, the extraction rules, or the output reconstruction logic. Consequently, the system cannot realize a closed feedback loop that enhances the quality of generated handover information across iterative runs, leading to repeated errors and missed insights.

Furthermore, existing solutions rarely incorporate a computation-oriented emotion recognition function that can adapt the presentation of AI-generated handover information to a user's emotional state. When a user is under stress, fatigue, or anxiety, conventional systems do not adjust the content density, ordering, or highlight level of displayed information. This results in suboptimal human-computer interaction, increased cognitive load, and higher risk of important items being overlooked. From the standpoint of computer system design, there is a need for a coordinated control mechanism by which a processor can use emotion-related signals to modulate the composition and presentation of UI content in an automated fashion.

Accordingly, there is a need for a computer-implemented system that: (1) acquires and normalizes business information from various sources, (2) structures the information into an input data set tailored to a generative AI model, (3) generates and updates a prompt sentence that instructs the generative AI model to produce handover-optimized outputs, (4) validates and reconstructs the model outputs into machine-stored, categorized handover information, (5) captures and associates user feedback with specific inputs and outputs, and (6) adjusts both the underlying processing logic and the user interface presentation, including emotion-aware display control. Such a system should improve the technical performance of the overall computing pipeline, namely, the accuracy, reliability, and adaptability of AI-driven handover support executing on a processor.

The specific processing by the specific processing unit 290 of the data processing device 12 in Example 1 is realized by the following means.

The present invention provides a server comprising a processor, a storage device, a communication interface, and a terminal interface, the processor being configured to execute instructions that cause the server to: acquire business information from a terminal device via the communication interface, normalize the business information into a predetermined machine-readable format, and store the normalized business information in the storage device; extract at least a portion of the stored business information, structure the extracted business information by category, and generate an input data set for a generative AI model based on the structured business information; generate a prompt sentence that instructs the generative AI model to analyze the input data set and to extract important information necessary for business handover, and supply the prompt sentence and the input data set as model input to the generative AI model; receive, as a model output, an analysis result from the generative AI model, verify a format and content of the analysis result, reconstruct the verified analysis result as handover information classified into at least one of a plurality of sections including a project progress section, a stakeholder section, a problem-and-solution section, an unresolved item section, a risk section, and a recommended action section, and store the handover information in the storage device in association with corresponding business information; transmit the handover information to the terminal device and cause the terminal device to display the handover information on a dashboard screen or a list screen; acquire, from the terminal device, feedback information including at least one of evaluation information, correction information, and comment information related to the handover information, and store the feedback information in the storage device in association with the analysis result and the business information; update, based on the feedback information, at least one of an extraction and structuring logic for the business information, a content of the prompt sentence for controlling the generative AI model, and a post-processing logic for the model output, such that accuracy of generation of the handover information is improved in a subsequent execution; and determine an emotional state of a user by using an emotion recognition function and adjust at least one of content and order of the dashboard screen based on the emotional state so as to optimize a handover process and reduce burden on the user and a successor. This enables a computer-centered improvement in which the server implements a closed-loop, data-driven orchestration of normalization, AI-based analysis, structured storage, adaptive prompting, feedback-based logic refinement, and emotion-aware presentation control, thereby enhancing technical performance of handover support processing in terms of accuracy, robustness, responsiveness, and user-adaptive behavior.

The term “business information” refers to data representing activities, events, states, or resources related to operation of an organization, including but not limited to records of projects, tasks, transactions, issues, resolutions, contacts, schedules, and performance indicators.

The term “terminal device” refers to an information processing apparatus operated by a user and communicatively connected to a server, including but not limited to a personal computer, a tablet device, or a smartphone that provides a user interface for data input and output.

The term “server” refers to an information processing apparatus or a group of information processing apparatuses comprising at least one processor, a storage device, and a communication interface, configured to execute programs to provide functions described in the present invention.

The term “processor” refers to a hardware computation unit, such as a central processing unit or a processing circuit, configured to execute machine-readable instructions to perform logical operations, data processing, and control functions in the system.

The term “storage device” refers to a hardware component configured to store data or programs, including volatile storage such as random access memory and non-volatile storage such as a magnetic disk device, a solid-state drive, or a flash memory.

The term “communication interface” refers to a hardware and software component configured to transmit and receive data between the server and external devices, including but not limited to network interface controllers and communication protocols for wired or wireless networks.

The term “normalize” refers to processing data into a predetermined, consistent representation, including operations such as converting formats, unifying units, standardizing timestamps, canonicalizing labels, and structuring fields into a machine-readable schema.

The term “input data set” refers to a collection of one or more data items derived from business information and structured in a predetermined format suitable for being supplied as input to a generative AI model.

The term “generative AI model” refers to a machine-learned model configured to generate output data, such as natural language text or structured data, from input data and instructions, for example by using a neural network model trained on large-scale data.

The term “prompt sentence” refers to a sequence of natural language or structured instructions supplied to a generative AI model, which specifies a task, a desired output format, or constraints for analyzing an input data set and generating output data.

The term “analysis result” refers to output data generated by the generative AI model in response to a prompt sentence and an input data set, including extracted items, classifications, summaries, or other transformed representations of business information.

The term “handover information” refers to information generated or reconstructed based on business information and an analysis result, the information being organized so that a successor can understand and continue an ongoing or past business activity.

The term “project progress section” refers to a logical category or portion of the handover information that describes advancement, status, milestones, or completion degree of one or more business projects.

The term “stakeholder section” refers to a logical category or portion of the handover information that describes persons, roles, or entities involved in business activities, including relationships, responsibilities, and contact information.

The term “problem-and-solution section” refers to a logical category or portion of the handover information that describes past or present issues, faults, or risks and corresponding resolutions, mitigations, or countermeasures.

The term “unresolved item section” refers to a logical category or portion of the handover information that describes tasks, issues, or decisions that remain open or incomplete at a time of generating the handover information.

The term “risk section” refers to a logical category or portion of the handover information that describes potential adverse events, uncertainties, likelihoods, and possible impacts related to business activities.

The term “recommended action section” refers to a logical category or portion of the handover information that describes suggested next steps, follow-up operations, or preventive measures for a successor or other users.

The term “dashboard screen” refers to a display screen presented on a terminal device, in which multiple elements of handover information are visually arranged in aggregated panels, charts, tables, or lists for overview and drill-down.

The term “list screen” refers to a display screen presented on a terminal device, in which items of handover information are arranged in a list or tabular format that can be scrolled, filtered, or sorted.

The term “feedback information” refers to data received from a user that expresses an evaluation, correction, or comment regarding handover information or an analysis result, including quantitative ratings, labels, and free-text input.

The term “extraction and structuring logic” refers to program instructions or rules executed by the processor to select relevant portions of business information and to arrange the selected portions into categories or formats for an input data set or handover information.

The term “post-processing logic” refers to program instructions or rules executed by the processor to transform, validate, classify, or format an analysis result output from a generative AI model into handover information.

The term “emotion recognition function” refers to processing performed by hardware and software that estimates an emotional state of a user based on input signals, such as text content, voice, physiological signals, user operations, or other behavioral indicators.

The term “emotional state” refers to a condition representing a user's affective or mental state, including but not limited to stress level, satisfaction, anxiety, or fatigue, as determined or estimated by the emotion recognition function.

The term “successor” refers to a person or entity that takes over responsibility for one or more business activities from another person or entity, and that uses handover information to continue such activities.

The term “predecessor” refers to a person or entity that previously held responsibility for one or more business activities and that provides or is associated with original business information used to generate handover information.

The term “continuity of business operations” refers to a capability of an organization to maintain performance of business activities without interruption or significant degradation, even when responsible personnel change.

The term “substitutability of business operations” refers to a capability of an organization to allow another person or entity to assume responsibility for a business activity without substantial loss of efficiency or knowledge, based on available handover information.

The term “retirement” refers to a situation in which a person permanently leaves a role or organization, resulting in a transfer or termination of responsibility for associated business activities.

The term “reassignment” refers to a situation in which a person moves from one role, position, or department to another within an organization, resulting in transfer of responsibility for associated business activities.

In one embodiment, a server cooperates with at least one terminal and at least one user to implement the claimed system. The server includes at least one processor, a main memory such as a random access memory, a non-volatile storage device such as a solid-state drive, and a communication interface such as an Ethernet or wireless network interface. The terminal includes a processor, a memory, a display device such as a liquid crystal display, and an input device such as a keyboard, a pointing device, or a touchscreen. The user operates the terminal to provide business information, to confirm generated handover information, and to supply feedback.

The server executes an operating system, such as a general-purpose server operating system, and an application stack including a web server, a backend application framework, and a database management system. In one example, the server executes a web server that terminates HTTPS connections, a backend application implemented in a server-side programming language, and a relational database such as a structured query language database. The server also communicates with a generative AI model execution environment, which may be hosted on the same hardware platform or on a separate computation node equipped with a graphics processing unit or another specialized accelerator.

The server stores program modules for data ingestion, normalization, data structuring, prompt construction, model orchestration, output validation, output reconstruction, feedback management, and emotion recognition. The server also stores configuration data, including definitions of categories for handover information, templates for a prompt sentence, and parameters for the generative AI model such as maximum token length, temperature, or output format constraints.

The user provides business information to the server by operating the terminal. The terminal executes a web browser or a dedicated client application and displays graphical user interface components such as file selection controls, text input areas, and control buttons. The user selects local files containing business information, for example spreadsheet files or comma-separated value files, and confirms an upload operation. The terminal reads the selected files from a file system and transmits the file content to the server via the communication interface using an encrypted application-layer protocol.

The server receives the uploaded files and stores them as raw data in the storage device. The server then executes a normalization module that converts the raw data into a standardized representation. The server applies parsing logic to read tabular structures, extract column headers and data rows, and map them to an internal schema. The server converts date fields to a normalized timestamp representation, converts numeric fields such as amounts or counts to normalized numerical types, and applies text normalization to business descriptions, including lowercasing, removal of redundant whitespace, and unification of character encodings. The server records the normalized records into one or more tables in the database, using identifiers to link related entities such as projects, contacts, and issues.

The server structures the normalized business information into an input data set for a generative AI model. The server executes a data structuring module that selects fields relevant to specific handover categories. For instance, the server groups fields related to project status, milestones, and deadlines into a project progress category; fields related to names, roles, and communication channels into a stakeholder category; and fields related to issue descriptions and resolutions into a problem-and-solution category. The server assembles these fields into a hierarchical data structure, such as a sequence of records or sections, that preserves relationships among projects, events, and participating actors.

The server converts the structured data into a text representation optimized for processing by a generative AI model. The server applies deterministic formatting rules to create a consistent layout, such as using section headers, bullet-like enumerations, and key-value pairs. In one example, the server uses a format such as “Project: [name]; Client: [identifier]; Status: [status]; Issues: [summary]; Resolutions: [summary]; Key contacts: [list].” The server applies a length control mechanism that truncates or summarizes excessively long portions of the text while preserving the most recent or most critical entries, in order to satisfy a token constraint of the generative AI model. By standardizing the structure and length of the text, the server reduces variability at the input of the generative AI model, which improves the stability and reproducibility of generated outputs.

The server generates a prompt sentence that directs the generative AI model to perform a specific analysis and to output handover-focused information. The server stores multiple prompt templates in the storage device. Each template includes placeholders for sections, time periods, organizational units, and output formatting requirements. For example, the server may use a template such as:

“Analyze the following business data and extract all information needed for an effective handover. Organize the output into sections: [section list]. Return the result in a structured textual format that clearly separates these sections.”

The server replaces the placeholders with concrete values according to the current analysis context. For example, for sales projects over the past year, the server may generate a prompt sentence such as:

“Analyze the following sales project data for the past year and extract all information that a new salesperson needs for an effective handover. Organize the output into sections: key projects, important contacts, ongoing risks, unresolved issues, and recommended next actions. Return the result as a clearly structured text that labels each section.”

In another example, the server may generate a prompt sentence for reflection and process improvement, such as:

“Review the past year's project history and identify the main successes, failures, and lessons learned. Suggest three concrete approaches that could improve our project management process next year, and explain why each approach would be effective.”

The server attaches the prompt sentence and the formatted input data set to a request for the generative AI model. The server tokenizes the prompt sentence and the structured data using a tokenizer corresponding to the trained generative AI model, and calculates the expected number of tokens to ensure compliance with the model's maximum sequence length. The server configures model inference parameters, such as sampling temperature or nucleus sampling threshold, through configuration data. The server then transmits a request to the generative AI model execution environment, including the sequence of tokens and the parameter set.

The generative AI model executes on specialized computation hardware. In one embodiment, the model is a transformer-based neural network including a stack of self-attention layers and feed-forward layers. The model includes input embedding matrices, positional encoding mechanisms, multiple attention heads per layer, and layer normalization units. The model parameters, including weight matrices and bias vectors, are stored in memory accessible to a graphics processing unit or other vectorized computation hardware. During execution, the model applies parallel matrix multiplications to compute self-attention scores and to propagate activations through the layers.

The server, or a separate inference orchestrator, supplies the tokenized prompt and input sequence to the generative AI model. The model computes an attention distribution across tokens, which enables the model to focus on relevant parts of the business information when generating an output token for each section. Due to the structured format enforced by the server and the prompt sentence that explicitly specifies the required categories, the attention mechanism can more effectively distinguish between fields such as project progress indicators and risk descriptions. As a result, the generative AI model produces an analysis result that is more accurately aligned to the handover information structure than a generic free-form summary.

The server receives the generated token sequence from the generative AI model and converts it back into text. The server then applies a validation module that checks whether the content includes the expected sections and whether each section follows at least a minimal syntactic pattern. The server searches for section labels, such as “Key projects:” or “Recommended next actions:”, and, when the labels are missing or incomplete, the server applies rule-based correction logic to infer the section boundaries using linguistic cues or line breaks. The validation module also detects cases where the generative AI model deviates from the required structure, and, in such cases, the server may re-issue a modified prompt sentence that includes stricter formatting instructions.

The server reconstructs the analysis result into internal domain-specific data structures. The server parses each section of the generated text into lists of items, extracting core fields such as project identifiers, risk descriptions, action descriptions, and stakeholder names using pattern matching and, optionally, lightweight auxiliary classifiers. The server stores each parsed item in tables dedicated to handover information in the database, maintaining identifiers that link each item back to the original business information records and to the specific generative AI model inference run.

The server transmits the reconstructed handover information to the terminal. The terminal receives a structured representation of the handover information and generates a dashboard display. The terminal renders multiple panels corresponding to the sections of handover information. For instance, a project progress panel may show a list of projects with status indicators, a stakeholder panel may list key contacts with roles and communication details, and a risk panel may display textual descriptions and severity levels. The terminal enables the user to filter and sort entries using graphical controls. By presenting the generated handover information in a structured, machine-derived layout, the terminal reduces the need for the user to manually navigate and interpret raw data tables.

The user reviews the handover information on the terminal. The user compares the generated items with personal knowledge and with the original business records presented in additional views. When the user identifies erroneous or incomplete items, the user can correct them through editing controls or can annotate them with comments explaining the discrepancy.

The terminal transmits these corrections and comments as feedback information to the server, together with identifiers indicating the corresponding handover item and inference run.

The server stores the feedback information in association with the business information and the analysis result. The server maintains a feedback schema in the database that includes fields for ratings, error categories, corrected text, and free-form commentary. The server periodically analyzes the feedback using statistical methods or auxiliary learning models. For example, the server can compute the frequency of feedback indicating missing risks for specific types of projects or the correlation between certain input patterns and low user ratings. The server uses these measurements to automatically adjust extraction and structuring logic, for example by adding rules that always include certain data fields when a particular project type is detected, or by reordering fields in the formatted input sequence to highlight risk-related information for the generative AI model.

The server also updates the content of prompt sentences according to accumulated feedback. When the server detects that the generative AI model repeatedly omits a required category, the server can modify the prompt template to emphasize that category, such as by adding explicit instructions like “Make sure to include at least one item in the unresolved issues section for every project that has open tasks.” The server can furthermore adjust parameters such as temperature to reduce variability and to favor more deterministic outputs when users report unpredictability as a problem.

The server incorporates an emotion recognition function that estimates a user's emotional state based on signals available at the terminal or server. In one embodiment, the terminal measures interaction patterns such as the rate of scrolling, frequency of edits, and hesitation times between actions, and transmits this operational data to the server. The server applies an emotion recognition model, which may be a classifier trained on behavioral features, to categorize the emotional state into classes such as “calm,” “stressed,” or “overloaded.” In another embodiment, the terminal may capture additional modalities, such as voice or facial expressions, subject to user consent, and extract low-level features that are input to the emotion recognition model.

The server uses the estimated emotional state to adjust the composition and ordering of information in the dashboard. When the server determines that the user is stressed, the server selects a simplified presentation mode that initially shows only the most critical items, such as high-severity risks and imminent deadlines, and defers less urgent items to secondary views. When the user's emotional state is calm or neutral, the server may display a more detailed view that includes extensive background data. By dynamically controlling the volume and ordering of displayed information in response to emotion recognition, the server reduces cognitive overload and increases the likelihood that the user correctly understands and acts on the most important handover information.

The use of the described processing pipeline produces technical effects beyond mere automation of human reading and summarization. By normalizing heterogeneous business information into a machine-tractable schema and by structuring the data into a controlled input format, the server reduces computational complexity and improves cache locality in database operations and in the generative AI model's attention computations. The deterministic formatting of input sequences and the feedback-driven refinement of prompt sentences reduce the variance of model outputs and reduce the number of model invocations required to obtain acceptable handover information, which in turn reduces processing time and network traffic between the server and the generative AI model.

The server's closed-loop feedback mechanism improves the technical performance of the generative AI model orchestration, because the server systematically updates the extraction logic and prompt content in direct response to structured, record-linked feedback. This enables the system to converge toward a configuration that minimizes specific error categories as measured over actual use, such as missing critical risks or misclassified stakeholders. As a result, the system increases the precision and recall of automatically identified handover items compared to static, manually configured rules.

The emotion-aware display control also yields technical improvements. By adapting the volume, ordering, and highlight intensity of displayed items based on predicted emotional state, the server reduces unnecessary rendering operations on the terminal and decreases the number of user interactions needed to access high-priority information. This leads to reduced bandwidth and processing load, because the server and terminal can defer fetching and drawing of low-priority sections when the user is in a high-stress condition.

In one variation, the server trains or fine-tunes the generative AI model using a corpus derived from historical business information and user-approved handover outputs. The server constructs training pairs consisting of an input data set, a prompt sentence, and a target output text that has been edited or confirmed by users. The server defines a loss function such as a token-level cross-entropy between the model's predicted distribution and the target tokens, and computes gradients via backpropagation through the transformer architecture. The server updates model weights using an optimizer such as stochastic gradient descent with momentum or an adaptive method. The server may perform data augmentation by paraphrasing template segments of prompt sentences or by synthesizing slight variations in project descriptions while preserving labels, in order to increase robustness to variations in input phrasing.

The server may also implement alternative generative models or hybrid architectures. In one embodiment, the server uses a smaller generative AI model for preliminary extraction and then applies a larger, more computationally intensive model only to items that the preliminary model flags as ambiguous or high-risk, thereby reducing average computation time. In another embodiment, the server combines a generative transformer with a retrieval component that queries a vector database of past handover cases using similarity search, and then includes retrieved examples in the prompt sentence to guide the generative AI model toward domain-consistent outputs.

The terminal can also adopt multiple user interface layouts depending on device characteristics. For example, on a smartphone, the terminal may present handover sections in a sequential, scroll-based layout, whereas on a desktop workstation, the terminal may display multiple panels in a grid, using additional screen space to provide comparative views. In either case, the server supplies structured handover information with metadata indicating relative priority or recommended layout, and the terminal uses this metadata to decide which components to render in an initial viewport.

Through these embodiments, the server, the terminal, and the user cooperate in a technically specific manner to implement a system that acquires, normalizes, structures, and analyzes business information with a generative AI model under explicit prompt control, reconstructs validated handover information, integrates structured user feedback into the processing pipeline, and adapts presentation based on emotion recognition. The resulting configuration improves the performance and behavior of the computing system itself in terms of computational efficiency, accuracy of extracted information, stability of AI outputs, and adaptive presentation, rather than merely automating existing human procedures.

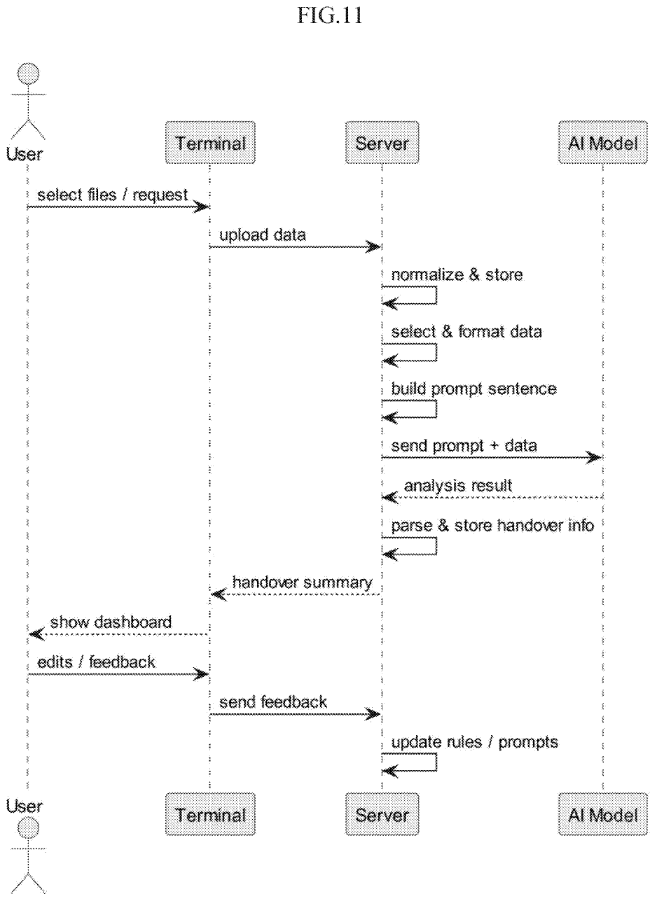

The following describes the processing flow using FIG. 11.

### Step 1:

The user operates the terminal to provide raw business information to the server.

The user selects one or more files containing business information, such as spreadsheet files or comma-separated value files, using a file selection interface displayed on the terminal. The terminal receives the selected file paths as input, reads the file contents from local storage, and constructs an upload request. The terminal encapsulates the file contents, user identifiers, and optional parameters (such as department and time range) into an encrypted communication message and transmits the message to the server via a network interface. The output of this step is a network request containing the raw business information that reaches the server.

### Step 2:

The server receives and stores raw business information from the terminal.

The server accepts the upload request via the communication interface as input, parses the message headers and body, and extracts binary file data and associated metadata. The server writes the raw file data to a temporary storage area on a storage device, assigning unique file identifiers to avoid collisions. The server also inserts a record into a database table that logs upload events, including user identifier, upload time, file identifier, and file type. The output of this step is a set of stored raw files and corresponding upload records registered in the database.

### Step 3:

The server normalizes the raw business information into a standardized internal schema.

The server reads the raw files and upload records as input and invokes a parsing module. The server uses a file parser to decode tabular structures, extracting header rows and data rows and mapping them to generic fields such as project_name, client_identifier, status, start_timestamp, end_timestamp, issue_text, and resolution_text. The server performs data conversions, including parsing date strings into timestamp objects, converting numeric strings into integer or floating-point values, and trimming or sanitizing text fields. The server then executes database insert operations that store each normalized record into one or more normalized tables, such as a project table, an issue table, and a contact table. The output of this step is a population of normalized, queryable records stored in the database with consistent field types and relationships.

### Step 4:

The server selects a subset of normalized business information for analysis.

The server uses user-specified parameters and internal configuration as input, including department, time range, and project status filters. The server formulates and executes database queries that join relevant tables, such as the project table and the issue table, to extract records that satisfy the filter conditions. The server groups the resulting rows by logical business unit, for example by project identifier, and aggregates related fields into in-memory data structures such as lists or dictionaries. The server may compute simple derived metrics, such as the count of unresolved issues per project, during this querying process. The output of this step is a structured in-memory collection of business entities selected for handover analysis.

### Step 5:

The server structures the selected business information into category-based data blocks.

The server takes the in-memory collection of selected entities as input and applies categorization rules. The server assigns fields related to completion rates and milestones to a project progress category, assigns fields related to persons and roles to a stakeholder category, and assigns issue and resolution text to a problem-and-solution category. The server organizes these categories into a hierarchical data structure, such as a nested list where each project entry includes sub-lists for progress, stakeholders, issues, unresolved items, risks, and recommended actions. The server also assigns internal identifiers to each item within these categories to maintain traceability. The output of this step is a set of structured category-based data blocks representing the selected business information.

### Step 6:

The server converts the category-based data blocks into a formatted text input for the generative AI model.

The server receives the category-based data blocks as input and applies deterministic formatting rules to generate a text sequence. The server iterates through each project and concatenates labeled fields into lines such as “Project: [name]; Client: [identifier]; Status: [status]; Main issues: [summary]; Resolutions: [summary]; Key contacts: [names].” The server inserts section headers like “Project progress,” “Important contacts,” and “Past issues and solutions” to clearly delineate categories. The server monitors the cumulative character or token length during this process, and if the length exceeds a predefined threshold, the server truncates or summarizes older or low-priority entries while preserving identifiers for critical items. The output of this step is a compact, consistently formatted text representation of the business data prepared for AI processing.

### Step 7:

The server generates a prompt sentence tailored to the current analysis context.

The server uses configuration data, including template prompt sentences and analysis metadata, as input. The server selects an appropriate template, such as a handover template or a reflection template, and replaces placeholders with context-specific values such as the business domain, time period, and desired sections. For example, the server may generate a prompt sentence:

“Analyze the following sales project data for the past year and extract all information that a new salesperson needs for an effective handover. Organize the output into sections: key projects, important contacts, ongoing risks, unresolved issues, and recommended next actions. Return the result as a clearly structured text that labels each section.”

The server stores the generated prompt sentence alongside the formatted data text. The output of this step is a combined instruction set consisting of the prompt sentence and the formatted input text.

### Step 8:

The server prepares and sends a request to the generative AI model.

The server takes the prompt sentence and the formatted text as input and passes them through a tokenizer associated with the generative AI model. The server transforms words and symbols into a sequence of token identifiers and measures the token count to ensure it is within the model's maximum input length. The server packages the tokenized prompt and data, along with inference parameters such as maximum output length and sampling temperature, into a request object. The server sends this request to the generative AI model execution environment over a network connection, using a defined application programming interface. The output of this step is a model inference request being submitted with a carefully prepared token sequence and parameter set.

### Step 9:

The server receives and decodes the analysis result from the generative AI model.

The server accepts the model's response as input, which includes a sequence of output tokens and other metadata. The server decodes the token sequence into a text string using the same tokenizer in reverse. The server then stores the raw generated text and associated metadata, such as model version and parameter settings, in a log table for traceability. The output of this step is a plain-text analysis result representing the generative AI model's interpretation and organization of the input business information.

### Step 10:

The server validates and segments the analysis result into predefined sections.

The server uses the raw analysis text as input and applies a validation and segmentation module. The server searches for expected section labels, such as “Key projects:”, “Important contacts:”, “Ongoing risks:”, “Unresolved issues:”, and “Recommended next actions:”. The server splits the text at these labels to isolate each section, trimming whitespace and removing extraneous formatting characters. If a section label is missing or ambiguous, the server applies rule-based heuristics to locate section boundaries, for example by analyzing line breaks or bullet-like patterns. The output of this step is a set of well-defined text segments, each corresponding to a specific handover section.

### Step 11:

The server parses section text into structured handover items.

The server takes each section text segment as input and applies parsing rules specific to the section type. For a “Key projects” section, the server splits lines into individual project items and extracts fields such as project name, brief description, and priority level using separators and pattern-based extraction. For a “Risks” section, the server identifies phrases indicating risk descriptions and, optionally, severity or likelihood indicators. The server converts the extracted information into structured records, assigning identifiers that link them to the corresponding original project or issue if matching patterns indicate such a link. The output of this step is a collection of structured handover records categorized by section and linked back to original business entities.

### Step 12:

The server stores structured handover information in the database.

The server uses the structured handover records as input and prepares database insertion operations. The server writes each record into dedicated handover tables, such as a handover_project table, a handover_risk table, and a handover_action table, including fields for content, category, source project identifier, and inference run identifier. The server also updates index structures to support efficient retrieval by project, category, or time. The output of this step is a persistent, queryable repository of handover information ready for retrieval and display.

### Step 13:

The server transmits handover information to the terminal for display.

The server reads relevant handover records from the database as input according to a user's request parameters (e.g., selected project or time frame). The server aggregates the records by section and formats them into a structured response message, including fields for titles, descriptions, and priority indicators. The server sends this response to the terminal over the communication interface. The output of this step is a structured handover information payload delivered to the terminal.

### Step 14:

The terminal renders the handover dashboard for the user.

The terminal receives the handover information payload as input and parses the structured data. The terminal generates graphical components for each section, such as tables for key projects, lists for important contacts, and panels for risks and recommended actions. The terminal uses local rendering logic to assign colors, icons, and layout positions based on metadata such as severity or priority. The terminal then updates the display device to show the dashboard, enabling scrolling, filtering, and expansion of items through user interface controls. The output of this step is a visual representation of handover information presented to the user.

### Step 15:

The user reviews and, if necessary, edits handover items on the terminal.

The user examines the displayed sections and selects specific items that appear incorrect, incomplete, or unclear. The terminal receives user interactions such as clicks, taps, or keyboard input as input events. The terminal opens an edit window when the user chooses to modify an item and allows the user to update text fields, adjust priority levels, or add clarifying comments. The terminal collects the modified content and associated identifiers and packages them into an update request. The output of this step is an update message containing corrected or annotated handover information, transmitted back to the server.

### Step 16:

The server records user corrections and feedback for future optimization.

The server receives the update message as input and extracts corrected content, comments, and item identifiers. The server updates corresponding handover records in the database, preserving both original AI-generated content and user-corrected content by storing them in separate fields or versions. The server also stores feedback-specific records that link the correction to the original model output and input data. The server may compute simple statistics, such as flags indicating which sections or item types frequently require correction. The output of this step is an augmented data set that now includes explicit user feedback tied to specific AI outputs.

### Step 17:

The server adjusts extraction logic and prompt configuration based on accumulated feedback.

The server periodically reads feedback records and original processing configurations as input. The server analyzes patterns in corrections and ratings, such as repeated omissions of certain risk types, and identifies triggers to modify extraction rules or prompt wording. The server updates configuration tables that define which fields must always be included for particular project types and modifies prompt templates to emphasize frequently missing sections. The server then activates the updated configurations for subsequent runs. The output of this step is an evolved set of extraction rules and prompt sentences that reduce recurring errors and improve the relevance of generated handover information.

### Step 18:

The terminal provides behavioral signals to support emotion recognition.

The terminal monitors user interaction patterns with the dashboard, including scrolling speed, frequency of opening detailed views, and duration of pauses between actions, as input signals. The terminal aggregates these signals over a defined time window and transmits them to the server along with session identifiers. The terminal does not infer emotions locally but provides raw or lightly processed behavioral metrics. The output of this step is a stream of behavioral data sent to the server for emotional state estimation.

### Step 19:

The server estimates the user's emotional state and adapts presentation control parameters.

The server receives behavioral data and, optionally, additional sensor-based data as input.

The server applies an emotion recognition function, such as a trained classifier that takes features like interaction rhythm and dwell times as input and outputs an emotional state label, for example “calm,” “stressed,” or “overloaded.” The server then maps each state label to presentation control parameters, such as the number of items to show initially or the emphasis level on high-priority items. The server updates session-specific settings stored in memory so that subsequent dashboard responses are tailored to the estimated state. The output of this step is a set of adjusted presentation parameters associated with the current user session.

### Step 20:

The server and terminal cooperate to present emotion-aware handover views.

The server uses the adjusted presentation parameters and current handover information as input when constructing response messages. For a “stressed” state, the server selects only high-priority sections and top-ranked items, reducing overall information volume. The terminal receives such a response and renders a simplified dashboard that highlights critical risks and immediate actions while hiding or collapsing less urgent categories. For a “calm” state, the server and terminal may present more comprehensive detail. The output of this step is an emotion-adaptive dashboard that reduces cognitive load and focuses user attention on the most important handover content.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

In many industrial and organizational environments, computer systems are used to collect business data and to support shift handovers or responsibility transfers between different workers. However, conventional systems typically rely on static templates, manual summarization, or simple rule-based processing of logs. As a result, several technical problems arise in terms of how computing resources handle, transform, and present large volumes of heterogeneous operational data for handover purposes.

First, conventional systems do not efficiently transform raw machine-state data and work logs into structured, analysis-ready data in an automated manner. Missing values, outliers, and inconsistent units in sensor data or work records often require manual cleaning or ad hoc scripts that are not integrated into a unified processing pipeline. This leads to fragmented data processing on the computer side, in which the processor, memory, and storage are not used in a coordinated way to generate reliable indicator values such as production amounts, stop times, inventory amounts, and abnormality statuses. As data volume and frequency increase, such manual or loosely coupled processing causes performance bottlenecks, inconsistent results, and increased latency in generating information for the next worker.

Second, existing computer systems have difficulty extracting context-aware, human-readable handover information from large and complex datasets. Conventional reporting modules usually apply fixed queries or pre-defined dashboards, which are not adaptive to the current operational context. As a consequence, the systems often either omit important situational information or overload the worker with raw data and generic metrics. This lack of adaptive summarization and prioritization at the system level results in inefficient use of processor cycles and storage I/O, because numerous low-level data items are retrieved, rendered, and transmitted to terminals without being transformed into concise, actionable information. Third, conventional systems do not integrate generative artificial intelligence models in a way that is specifically configured for handover optimization and for improving continuity and substitutability of work among different workers. Even when a generative AI model is used, the model is often invoked in an ad hoc manner, without a well-defined mechanism for generating context information, constructing a prompt sentence, and tying the model's outputs to structured evidence stored in persistent storage. This leads to unstable system behavior, lack of reproducibility, and difficulty in auditing or reusing past AI-generated outputs as part of the system's operational history.

Fourth, existing systems generally lack mechanisms by which the processor can manage the completion of a handover process based on machine-readable events such as viewing status of handover information and work-start status on terminals. Instead, completion of handover is often assumed or recorded manually, so the computer system has no reliable internal state representing whether a shift has been effectively handed over. This limits the ability of the system to autonomously control workflows, to trigger new data collection or analysis cycles, and to guarantee that later operations are based on confirmed, reviewed information. Fifth, conventional systems do not maintain a unified, machine-processable history that links work-related information, AI-generated handover information, prompt sentences, and operation histories of workers. As a result, the computing platform cannot effectively leverage past interactions to improve future handovers, ensure continuity when a person in charge changes due to retirement or reassignment, or systematically refine the quality of AI prompts and outputs. This lack of integrated historical data structures degrades the long-term performance and reliability of the system as a technical platform.

Accordingly, there is a need for an improved computer-implemented system that integrates data collection, preprocessing, generative AI-based summarization, structured storage of both inputs and outputs, and automated management of handover completion. Such a system should technically enhance how a processor coordinates memory, storage, and network interfaces to generate context-aware, consistent, and auditable handover information, thereby improving the overall functioning of the computer system used for shift handover and work continuity.

The specific processing by the specific processing unit 290 of the data processing device 12 in Application Example 1 is realized by the following means.

The present invention provides a server comprising a processor and a storage structure, the processor being configured to collect work-related information from at least one information source and store the work-related information in the storage structure; acquire the work-related information from the storage structure and generate analysis data by performing preprocessing including completion of missing values, removal of outliers, and calculation of indicator values; generate context information based on the analysis data and generate a prompt sentence that instructs a generative AI model to perform analysis of the work-related information and to generate handover information; input the context information and the prompt sentence into the generative AI model and cause the generative AI model to generate, in natural language, the handover information and work improvement proposals; format the handover information and the work improvement proposals in accordance with a predetermined item structure and store the formatted handover information and the formatted work improvement proposals in association with evidence information and generation condition information in the storage structure; distribute the handover information and the work improvement proposals to an information terminal including a display device and cause the information terminal to display the handover information and the work improvement proposals in a format viewable by a worker; acquire viewing status of the handover information by the worker and work-start status of the worker, and manage completion of a handover process based on the viewing status and the work-start status; and accumulate the work-related information and an operation history of the worker as history information in the storage structure and ensure continuity and substitutability of work among different workers based on the history information. This enables the computer system to implement an integrated, automated pipeline that converts raw operational data into preprocessed analysis data, generates context-aware prompt sentences and AI-based handover summaries, maintains structured and auditable records of both data and AI outputs, and programmatically determines completion of handover based on terminal interactions, thereby improving the overall functioning, reliability, and efficiency of the computer technology used for shift handover and organizational work continuity.

The term “work-related information” refers to information indicating a state, result, or context of work execution, including at least machine operation logs, sensor readings, production results, inventory records, event logs, and operator input data.

The term “information source” refers to any hardware or software component that provides work-related information, including at least sensors, controllers, data acquisition devices, application programs, databases, and user interfaces.

The term “storage structure” refers to any logical or physical data storage arrangement used to store work-related information and related data, including at least databases, file systems, memory structures, and data tables.

The term “analysis data” refers to data generated by processing and transforming collected work-related information, the analysis data including at least cleaned, normalized, and aggregated values and calculated indicator values suitable for further computation and analysis.

The term “preprocessing” refers to a sequence of operations applied to work-related information before analysis or model input, including at least completion of missing values, removal or marking of outliers, normalization or unification of units, aggregation of data, and calculation of indicator values.

The term “missing values” refers to data items that are expected by a data schema or processing rule but are absent, undefined, or invalid in the collected work-related information.

The term “outliers” refers to data values that significantly deviate from expected ranges or statistical distributions and are considered to be erroneous, anomalous, or unrepresentative in the context of the work-related information.

The term “indicator values” refers to numerical or categorical values derived from work-related information to represent operational characteristics, including at least production amounts, stop times, inventory amounts, abnormality occurrence statuses, and performance metrics.

The term “context information” refers to textual or structured information generated based on analysis data that summarizes, organizes, or highlights relevant aspects of work-related information to be provided as input context to a generative AI model.

The term “prompt sentence” refers to a sequence of characters or tokens, including at least one natural language instruction, that specifies to a generative AI model how to analyze context information and what type of output, such as handover information or work improvement proposals, should be generated.

The term “generative AI model” refers to a computation model, implemented in software and executed by hardware, that generates new data such as natural language text based on input data and a prompt sentence, the model including at least a neural network or other machine learning architecture capable of probabilistic sequence generation.

The term “handover information” refers to information generated for transfer of work responsibility between workers, including at least completed tasks, uncompleted tasks, material status, abnormalities related to work apparatus, and recommended subsequent actions.

The term “work improvement proposals” refers to information generated to suggest changes, enhancements, or optimizations to work procedures, task ordering, resource usage, or maintenance actions based on analysis data and context information.

The term “predetermined item structure” refers to a defined format or schema specifying sections, fields, or items to be included in handover information or work improvement proposals, such as headings, lists, categories, and mandatory data elements.

The term “evidence information” refers to data used to verify or trace the basis of generated outputs, including at least references to underlying work-related information, associated timestamps, data sources, and related operational events.

The term “generation condition information” refers to information describing conditions under which the generative AI model produced a particular output, including at least the version of the model, parameter settings, prompt sentences, time ranges of data used, and configuration values.

The term “information terminal” refers to an electronic device configured to communicate with the server and present information to a worker, including at least a workstation, a portable information device, a tablet, or a smartphone equipped with a display device and an input interface.

The term “display device” refers to a hardware component capable of visually presenting information, including at least liquid crystal displays, organic light-emitting diode displays, or other image display panels.

The term “worker” refers to a person who performs tasks in an organization or industrial environment and who uses an information terminal to view handover information, work improvement proposals, or related data.

The term “viewing status” refers to information indicating whether, when, and to what extent a worker has accessed, opened, scrolled through, or otherwise viewed specific handover information on an information terminal.

The term “work-start status” refers to information indicating that a worker has initiated or is performing a task or set of tasks, including at least explicit user inputs, system log entries, or machine operation events that satisfy predefined criteria for work commencement.

The term “handover process” refers to a sequence of operations relating to transfer of work responsibility from one worker to another, including generation, distribution, viewing, confirmation, and storage of handover information.

The term “history information” refers to accumulated records of work-related information, handover information, work improvement proposals, prompt sentences, model configurations, and operation histories of workers, stored for later reference, analysis, or auditing.

The term “continuity of work” refers to a condition in which work tasks and operational objectives proceed without interruption or loss of necessary information despite changes in workers or shifts.

The term “substitutability of work” refers to a capability by which different workers can perform the same or related tasks without significant degradation in performance or quality due to availability of sufficient contextual and historical information.

The term “state information” refers to information representing a current or past condition of a work apparatus, including at least operating mode, temperature, speed, error states, and other machine parameters.

The term “operation information” refers to information representing operation results or actions of a work apparatus, including at least production counts, cycle times, stop durations, fault occurrences, and other performance-related data.

The term “detection device” refers to a hardware component configured to obtain state information or operation information from a work apparatus, including at least sensors, detectors, meters, and monitoring modules.

The term “work apparatus” refers to any machine, equipment, or system used to perform work in an industrial or organizational environment, including at least production machines, processing devices, assembly lines, and handling systems.

The term “production amount” refers to an indicator value representing a quantity of items, units, or tasks completed by a work apparatus or process during a specified time period.

The term “stop time” refers to an indicator value representing a duration during which a work apparatus is not performing intended operations, including both planned and unplanned stoppages.

The term “inventory amount” refers to an indicator value representing a quantity of materials, parts, products, or consumables available for use in work processes at a given time.

The term “abnormality occurrence status” refers to an indicator value representing presence, type, frequency, or severity of abnormal events in a work apparatus or process, including errors, alarms, or deviations from normal operating conditions.

The term “completed tasks” refers to tasks that have been designated in a work plan and have been finished according to predefined completion criteria.

The term “uncompleted tasks” refers to tasks that have been designated in a work plan but have not yet been finished or have been only partially executed at the time of generating handover information.

The term “status of materials” refers to information indicating availability, quantity, or condition of materials, parts, or consumables relevant to work tasks.

The term “abnormalities relating to the work apparatus” refers to abnormal conditions, events, or behaviors detected or inferred in relation to a work apparatus, including faults, errors, unusual performance, or safety-related issues.

The term “recommended task order” refers to an ordered sequence of tasks suggested by the system as an efficient or appropriate execution order based on analysis data, context information, or model outputs.

The term “person in charge” refers to a worker who holds primary responsibility for certain tasks, equipment, or processes within an organization.

The term “retirement or reassignment” refers to a change in the person in charge resulting from the person leaving a role permanently or moving to a different role or position, thereby necessitating a transfer of work responsibilities.

In one embodiment, a server, a terminal, and a user cooperate to implement the present invention. The server includes at least one processor, a main memory, a non-volatile storage device, and a network interface. The server runs an operating system such as a general-purpose server operating system and executes application software written, for example, in a programming language such as Python. The server uses software libraries such as a numerical computation library, a data analysis library, and a deep learning framework for processing work-related information and for controlling a generative AI model.

The server connects, via the network interface, to one or more work apparatuses located in an industrial facility or an organization. The work apparatuses are equipped with detection devices, such as sensors and controllers, that output state information and operation information. The server communicates with the detection devices by using communication protocols supported by the controllers, such as an industrial fieldbus protocol or an application-level protocol over a transport layer protocol. The server receives raw data packets that include, for example, timestamps, machine identifiers, operation counters, error codes, production counts, and measured physical values.

The server stores the received raw data in a storage structure such as a relational database system (for example, a database management system conforming to SQL) or a structured file system. The server defines tables or records that include fields such as apparatus identifier, data type, value, unit, and timestamp. The server also stores metadata relating to each data item, such as sampling interval, detection device identifier, and data quality flags. By structuring the raw data in this manner, the server reduces search time and memory usage when later retrieving data for analysis.

The server uses a data analysis library such as a table-based data handling library to load work-related information from the storage structure into memory. The server performs preprocessing to generate analysis data. The server completes missing values by applying interpolation methods or by inserting predetermined default values depending on the data type. The server identifies outliers by using statistical measures such as standard deviation thresholds, interquartile ranges, or domain-specific limits stored as configuration data. The server removes or marks such outliers so that downstream analysis and model input are not distorted.

The server normalizes or converts units of the work-related information so that, for example, times are expressed in a common unit and production amounts are aggregated to common intervals. The server calculates indicator values such as production amounts, stop times, inventory amounts, abnormality occurrence statuses, and additional performance metrics. The server stores these indicator values in a dedicated analysis table in the storage structure. This structured representation enables the server to reduce the amount of data that must be retrieved and transmitted for later processing, thereby reducing communication load and improving memory locality.

The server generates context information based on the analysis data. The server converts the indicator values and key events into natural language or semi-structured textual descriptions. For example, the server constructs sentences such as: “Work apparatus A produced 420 units in the last shift, with a total stop time of 35 minutes and 3 abnormality events.” The server concatenates these sentences into a context string representing the recent operational situation of multiple work apparatuses and related tasks. The server may also include trend information computed from historical analysis data, such as increasing stop times or decreasing production amounts, by applying time-series analysis algorithms.

The server generates a prompt sentence for a generative AI model. The server configures the prompt sentence according to a handover template, including instructions for what type of information the model should generate. For example, the server may generate a prompt sentence such as:

“Based on the work data from the past 24 hours, generate the shift handover information required for the next operator. Emphasize the parts inventory status and the progress of each assembly task. Highlight any machines with abnormal stop frequency or extended cycle times, and propose a recommended order of tasks for the next shift.”

The server concatenates the context information and the prompt sentence to create an input sequence for the generative AI model. The server uses a generative AI model implemented, for example, as a transformer-based neural network with an encoder-decoder or decoder-only architecture. The server stores model parameters (weights) in the storage device and loads them into memory at runtime. The server uses a deep learning framework such as a tensor computation library to execute the model on a central processing unit or an accelerator such as a general-purpose graphics processing unit.

The server represents the input sequence as tokenized numerical data using a tokenizer associated with the generative AI model. The server feeds the tokenized input through multiple neural network layers that include self-attention mechanisms, feedforward networks, and normalization layers. The server computes attention weights over the context tokens and the prompt sentence tokens so that the model focuses on relevant parts of the analysis data when generating output tokens. The server controls decoding parameters such as temperature, top-k or nucleus sampling thresholds, and maximum output length to balance diversity and determinism of the generated text.

The server trains the generative AI model in advance using supervised learning techniques on domain-relevant text corpora that include historical handover reports, operational logs, and expert-written summaries. The server (or another training system) minimizes a loss function such as cross-entropy between predicted tokens and ground-truth tokens, and updates the model's parameters using an optimization algorithm such as stochastic gradient descent or an adaptive optimization method. The server may perform fine-tuning on data specific to a particular facility or apparatus type, thereby improving the accuracy of generated handover information. The training process may also use regularization methods and data augmentation techniques such as noise injection or prompt variation to increase robustness.

The server causes the generative AI model to generate output tokens representing natural-language handover information and work improvement proposals. The server decodes the tokens into text and performs post-processing such as removing incomplete sentences, enforcing section headings, or ensuring that mandatory items are present. The server then structures the generated text according to a predetermined item structure, which includes sections such as “Completed Tasks”, “Uncompleted Tasks”, “Material Status”, “Abnormalities”, and “Recommended Task Order”. The server associates this structured output with evidence information, including references to the underlying indicator values and raw data entries used for generation, and with generation condition information, including model version, prompt sentence, context time range, and parameter settings.

The server stores the structured handover information and work improvement proposals in the storage structure. The server assigns unique identifiers and timestamps to each report and maintains links to the relevant analysis data and raw data. The server also stores the prompt sentence and context information used in the generation. This enables later reconstruction of the exact input to the generative AI model and supports auditing, debugging, and incremental improvement of the system. By indexing these records, the server allows efficient retrieval of past handover information for training, evaluation, or comparison, thereby improving data management and computation efficiency.

The server distributes the handover information and work improvement proposals to a terminal. The terminal is a computing device such as a portable terminal, a workstation, or a panel-mounted device, equipped with a display device and an input interface. The terminal executes a client application or a web browser that communicates with the server via a network protocol such as HTTP over a secure transport layer. The terminal requests the latest handover information for a particular shift, line, or apparatus. The server responds with structured data, which the terminal parses and renders as a user interface.

The terminal displays, on the display device, the sections of the handover information in a layout designed for quick understanding. For example, the terminal presents a summary card showing total production, major issues, and critical inventory items, followed by detailed lists of completed tasks, uncompleted tasks, and recommended task order. The terminal highlights abnormalities and urgent items using graphical emphasis. The terminal may also provide hyperlinks or controls that allow the user to drill down into underlying data or past reports stored by the server.

The user operates the terminal to review the handover information before starting work. The user may acknowledge having read specific sections by pressing confirmation buttons. The terminal transmits these interactions to the server as viewing status data. The user then performs physical operations on the work apparatuses, such as starting, stopping, or adjusting them. The server detects work-start status by receiving specific operation events from the work apparatuses or by receiving explicit user input from the terminal indicating that a particular task has begun. The server records both the viewing status and the work-start status in the storage structure.

The server manages completion of the handover process based on the viewing status and work-start status. For example, the server sets an internal flag indicating that handover is complete when the user has viewed all mandatory sections of the handover information and has started at least one designated task. The server stores this completion information as part of history information. The server uses this internal state to control further automatic processing, such as starting a new data collection cycle or allowing configuration changes only after a completed handover. This machine-readable representation of handover completion improves the reliability of subsequent automated decisions and resource allocation on the server.

The server accumulates history information comprising work-related information, handover information, work improvement proposals, prompt sentences, and operation histories. The server uses this history to improve continuity and substitutability of work among different workers. For example, when a person in charge is changed due to retirement or reassignment, the server provides to a new user access to past handover reports, anomalies, and improvement proposals related to a given apparatus or task set. The server may also use the accumulated history to refine prompts, adjust model parameters, or retrain the generative AI model, thereby improving the accuracy and consistency of future handover information.

The server improves computer technology in several respects. By generating analysis data and indicator values and by passing compact context information instead of raw sensor streams to the generative AI model, the server reduces the amount of data processed by the model and reduces network and memory bandwidth usage. This improves processing speed and reduces latency from data acquisition to display of handover information. By explicitly defining and enforcing a predetermined item structure for handover information, the server reduces parsing and rendering effort on the terminal and avoids redundant data transfers.

The server also improves technical accuracy of the generated handover information by integrating statistical preprocessing and domain-specific indicator calculation prior to generative processing. This reduces the effect of noise, missing values, and outliers on the model input compared with naive approaches that directly feed raw logs to a language model.

The server's training and fine-tuning methodology, including use of cross-entropy loss, adaptive optimization, and data augmentation, results in a model that produces more consistent and context-appropriate summaries. The system thus reduces error rates in describing actual machine states and work progress.

The server applies non-conventional processing rules that differ from simple human summarization or business rule automation. For example, the server computes attention-based weights within the generative AI model to automatically prioritize machines with higher abnormality occurrence status or with inventory below threshold, even when such conditions are not explicitly listed in static rules. The server can also adjust prompt sentences dynamically based on indicator thresholds, such that when repeated minor stops are detected, the prompt emphasizes root-cause investigation, while in stable conditions, the prompt emphasizes efficiency optimization. This dynamic prompt construction and model conditioning cannot be easily replicated by manual procedures and results in more efficient and technically improved use of computational resources.

The server uses model-internal criteria, such as attention scores and token probability distributions, to filter or rank candidate outputs and to enforce constraints, for example that every handover report must contain explicit statements about uncompleted tasks and machine abnormalities. These criteria serve as internal technical rules that the server uses to generate consistent output structures, thereby improving downstream processing such as automated indexing or search within the storage structure.

In another embodiment, the server uses an alternative generative AI model architecture, such as a recurrent neural network or a hybrid model combining a transformer encoder with a recurrent decoder. The server may also use different optimization algorithms, such as second-order optimization, during training. The server may vary the set of indicator values or preprocessing methods depending on the type of work apparatus, such as incorporating energy consumption metrics, quality defect counts, or maintenance logs for certain apparatuses. The server may further implement compression or caching mechanisms for context information, for example by storing precomputed embeddings of historical data segments and reusing them across multiple prompt sentences to reduce repeated computation.

In yet another embodiment, the server executes the generative AI model on different hardware configurations, such as a dedicated accelerator or a distributed processing cluster.

The server partitions the input context and distributes computation across multiple processing nodes, then aggregates the partial results. This configuration enables handling larger context windows and more detailed indicator sets without degrading response time, further enhancing system scalability and technical performance.

The terminal may vary in form factor. In one embodiment, the terminal is a stationary panel attached to a production line and continuously displays updated handover and status information. In another embodiment, the terminal is a portable device carried by the user, which receives push notifications from the server whenever new handover information is generated. In any case, the terminal uses data structures such as cached response objects and local state flags to track which portions of the handover information have been viewed. The terminal periodically transmits this viewing status to the server in a compressed format, thereby reducing communication load while maintaining sufficient granularity for accurate handover completion management.

Through these embodiments, the server, the terminal, and the user cooperate to realize a computer-implemented system in which generative AI model processing is tightly integrated with structured data management, prompt sentence control, and device-level status tracking. This integration yields technical effects including improved processing speed, reduced communication and storage overhead, increased accuracy and consistency of generated information, and enhanced capability for the computer system to autonomously determine and manage the completion of handover processes, beyond mere automation of human mental tasks.

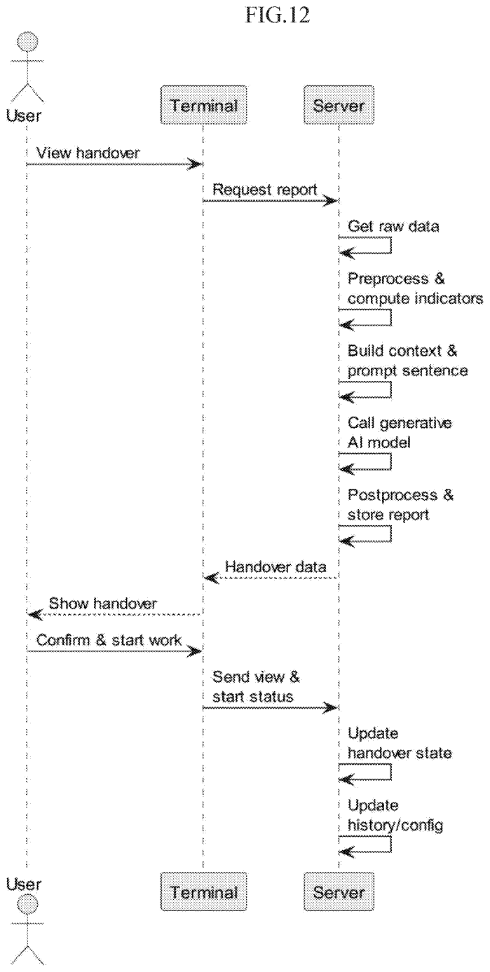

The following describes the processing flow using FIG. 12.

### Step 1:

The server acquires raw work-related information from detection devices and information sources.

The input is raw data streams including sensor readings, controller logs, timestamps, apparatus identifiers, and operator input events.

The server uses a network interface to receive packets via protocols such as an industrial fieldbus protocol or HTTP, parses packet headers to identify source devices, and extracts payload fields such as cycle counts, error codes, production counts, and measured values.

The server converts the raw payload into internal data records, for example key-value pairs in memory, attaches a reception timestamp, and assigns a unique record identifier.

The output is a set of normalized raw data records temporally ordered and tagged with device and apparatus identifiers.

### Step 2:

The server stores the normalized raw data records into a storage structure.

The input is the set of normalized raw data records generated in Step 1.

The server maps each record to a relational schema or structured file format, converts in-memory representations to database fields, and constructs insert operations that include fields such as apparatus_id, parameter_type, value, unit, timestamp, and quality_flag.

The server batches multiple insert operations into a single transaction, executes the transaction on a database management system, and writes transaction results to an application log.

The output is a persistent dataset of raw work-related information stored in tables or files, indexed by time, apparatus, and parameter type.

### Step 3:

The server retrieves stored work-related information for a specified analysis period.

The input is a query condition specifying at least a time range, a set of apparatus identifiers, and required parameter types.

The server generates and executes database queries, scans indices to locate relevant records, and loads the matching records into main memory using data analysis structures such as in-memory tables.

The server groups the retrieved records by apparatus, time interval, and parameter type to prepare for preprocessing and aggregation.

The output is a grouped in-memory dataset of raw records ready for preprocessing.

### Step 4:

The server performs preprocessing to generate analysis data.

The input is the grouped in-memory dataset from Step 3.

The server detects missing values by comparing expected sampling intervals and required fields against the actual dataset, fills missing numeric values using interpolation or default values, and marks missing categorical values with special tokens.

The server identifies outliers by computing statistics such as mean and standard deviation or by comparing values with configured thresholds, and removes or flags records whose values deviate beyond a specified criterion.

The server converts units so that values of the same type share a common unit, aggregates records into time windows, and calculates indicator values such as production amount per window, total stop time, inventory amount, and abnormality occurrence status.

The output is a structured set of analysis data that includes cleaned, normalized records and calculated indicator values for each apparatus and time period.

### Step 5:

The server generates context information from the analysis data.

The input is the structured set of analysis data produced in Step 4.

The server selects key indicator values, such as current inventory relative to safety thresholds, frequency of abnormal events, and completion ratios of planned tasks.

The server converts these selected values into textual descriptions, concatenates descriptions per apparatus and per shift, and orders them by priority such as anomaly severity or production impact.

The server may compress the context by removing redundant details and by limiting the number of records included according to predetermined rules to reduce input size for the generative AI model.

The output is a context string or structured text block that summarizes the recent operational state and key metrics.

### Step 6:

The server constructs a prompt sentence for the generative AI model.

The input is configuration data specifying a handover template, current operational objectives, and priority topics together with the context string from Step 5.

The server fills template slots with references to the context, determines which sections (e.g., inventory, abnormalities, task status) must be emphasized, and generates natural-language instructions describing the desired output format and content.

The server produces at least one prompt sentence such as “Based on the work data from the past 24 hours, generate the shift handover information required for the next operator.

Emphasize the parts inventory status and the progress of each assembly task. Highlight any machines with abnormal stop frequency or extended cycle times, and propose a recommended order of tasks for the next shift.”

The output is a prompt sentence that explicitly instructs the generative AI model how to analyze the context information and what type of handover information to generate.

### Step 7:

The server prepares model input by combining the context information and the prompt sentence.

The input is the context string from Step 5 and the prompt sentence from Step 6.

The server concatenates the context and the prompt into a single input sequence or encodes them into separate segments depending on the model architecture.

The server applies a tokenizer associated with the generative AI model to convert the text sequence into token identifiers, and assembles these identifiers into tensors suitable for model inference.

The output is a tokenized input tensor representing both the context and the prompt sentence.

### Step 8:

The server invokes the generative AI model to generate handover information and work improvement proposals.

The input is the tokenized input tensor from Step 7 and model parameters stored in memory.

The server executes forward passes through multiple neural network layers, computes attention scores over the input tokens, and generates a probability distribution over output tokens at each decoding step.

The server applies decoding strategies such as beam search or top-k sampling, selects output tokens iteratively according to configured temperature and sampling parameters, and stops generation when an end-of-sequence condition or maximum length is reached.

The output is a sequence of output token identifiers representing natural-language text that contains draft handover information and work improvement proposals.

### Step 9:

The server decodes and post-processes the generated text.

The input is the sequence of output token identifiers produced in Step 8.

The server converts token identifiers back into characters or words using the tokenizer's vocabulary, joins them into text, and removes artifacts such as incomplete fragments or extraneous tokens.

The server parses the generated text to identify logical sections corresponding to completed tasks, uncompleted tasks, material status, abnormalities, and recommended task order, and restructures the text to conform to a predetermined item structure.

The server checks for missing mandatory sections or inconsistent references, and, if necessary, inserts default phrases or triggers regeneration for specific parts according to internal rules.

The output is structured handover text segmented into labeled sections and ready for storage and presentation.

### Step 10:

The server associates the structured handover text with evidence and generation condition information and stores it.

The input is the structured handover text from Step 9, the underlying analysis data from Step 4, the raw data references from Step 2, and configuration data used in Steps 6-8.

The server creates a report record including a unique report identifier, time range, apparatus scope, prompt sentence, model version, and generation parameters, and links this record to tables containing indicator values and raw data identifiers.

The server writes the report record and links into the storage structure using transactional operations and updates indices to allow efficient retrieval by report identifier, time, or apparatus.

The output is a persistent, auditable handover report stored with complete traceability to its data sources and generation conditions.

### Step 11:

The server distributes the stored handover report to the terminal.

The input is a request from the terminal specifying, for example, a target shift or apparatus and authentication data of the user.

The server authenticates the request, retrieves the corresponding handover report and related metadata from the storage structure, and converts the structured report into a response format such as a structured document or a data object.

The server may compress the response and remove nonessential fields to reduce network bandwidth usage, and then transmits the response to the terminal over a secure channel.

The output is a transmitted data payload containing the latest handover information and work improvement proposals for display on the terminal.

### Step 12:

The terminal receives and renders the handover information.

The input is the data payload transmitted from the server in Step 11.

The terminal parses the structured data, maps report sections to user interface components, and updates display elements such as summary panels, lists of tasks, indicators of material status, and abnormality alerts.

The terminal maintains local state flags indicating which sections are currently visible and what user actions are available, and may cache the data for offline viewing.

The output is a graphical user interface on the display device that presents the handover information in a format viewable and operable by the user.

### Step 13:

The user interacts with the terminal to review and confirm the handover information.

The input is the graphical user interface rendered by the terminal in Step 12.

The user scrolls through the sections, opens detailed views, and reads recommendations such as the recommended task order, and then operates input controls such as buttons or checkboxes to acknowledge understanding or completion of review.

The user may add comments or corrections through text input fields, which the terminal captures as additional data associated with the report.

The output is a set of interaction events, including viewing actions, acknowledgments, and optional comments, which are transmitted from the terminal to the server.

### Step 14:

The server records viewing status and work-start status and manages handover completion.

The input is the interaction events from the terminal in Step 13 and operation events from work apparatuses indicating task initiation.

The server analyzes timestamps and event types to determine which sections the user has viewed and whether required acknowledgments have been supplied, and checks apparatus events to confirm that designated tasks have started.

The server updates records in the storage structure to store viewing status per section and per user, sets flags indicating whether handover requirements are satisfied, and marks the handover process as complete when predetermined criteria are met.

The server may trigger subsequent processes such as initiating a new data collection cycle or adjusting alert thresholds based on the completion state.

The output is an updated internal handover status and history information reflecting that the handover process has been completed or is still pending.

### Step 15:

The server updates history information and optionally refines future processing based on accumulated data.

The input is the completed handover report, associated evidence and generation conditions, user interactions, and subsequent operational outcomes (for example, machine performance or incident occurrences).

The server aggregates these elements into history records, computes performance metrics such as correlation between recommendations and reduced abnormalities, and identifies patterns that indicate strengths or weaknesses in current prompt sentences or model settings.

The server may adjust configuration parameters, such as which indicator values to emphasize in context information or how to phrase prompt sentences for particular apparatus types, and may schedule retraining or fine-tuning of the generative AI model using newly accumulated handover and outcome data.

The output is an updated set of history records and refined configuration data that improve technical performance, accuracy, and efficiency of future handover information generation.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2.

The units of the system described below are implemented by the data processing device 12 and the smart device 14. The data processing device 12 is called a “server” and the smart device 14 is called a “terminal”.

Conventional handover support systems in business environments typically rely on static templates, manual data entry, and rule-based workflows. Such systems merely store documents and task lists without deeply understanding the semantic content, temporal structure, or interdependencies of ongoing work. As a result, when a person in charge changes due to retirement, reassignment, or other personnel changes, the successor must manually analyze dispersed work-related information across multiple applications, such as scheduling tools, task management tools, and communication tools. This manual analysis leads to delays, human errors, and inconsistent continuation of work.

From a computing technology standpoint, existing systems treat business handover as a simple data storage and retrieval problem, and do not leverage advanced machine learning models in a way that integrates: (i) contextual analysis of heterogeneous work-related data, (ii) automatic generation of machine-consumable prompt sentences for a generative AI model, (iii) closed-loop control of external work support apparatuses based on model outputs, and (iv) adaptive presentation of information that reflects user emotion. There is no unified computational mechanism that transforms raw operational logs and handover documents into structured, actionable control signals for external systems while simultaneously maintaining a persistent, machine-readable history for successors.

In particular, known systems fail to provide a processor-implemented pipeline that: (a) automatically obtains work-related information from storage, (b) composes analysis target datasets that explicitly represent progress states and unexecuted work items, (c) generates context-aware prompt sentences for a generative AI model, (d) parses the generative AI model's output into executable actions, (e) automatically invokes schedule management, work registration, and notification transmission through external interfaces, and (f) records those operations as structured history information that can be re-used as training context for subsequent inference. This lack of integration prevents the computing system from behaving as an autonomous continuity engine for work operations.

Furthermore, conventional implementations do not incorporate emotion analysis of the user into the computational control loop. They do not dynamically adjust the content, granularity, or timing of prompts and summaries according to recognized emotional states, such as stress or overload of a successor. This leads to a user interface that is static and insensitive to human factors, potentially exacerbating cognitive burden at critical handover moments.

Accordingly, there is a need for an improved computer-implemented system that technically enhances the way processors manage business handover, by: (i) using generative AI models as a core inference engine over structured work-related datasets, (ii) automatically generating and consuming prompt sentences as machine-level control artifacts, (iii) orchestrating multiple external work support apparatuses within a unified programmatic framework, and (iv) adaptively controlling the user-facing presentation layer based on emotion analysis. Such a system should improve the efficiency, reliability, and continuity of work operations, and reduce the computational and cognitive overhead normally required for effective handover.

The specific processing by the specific processing unit 290 of the data processing device 12 in Example 2 is realized by the following means.

The present invention provides a server comprising a processor and a storage device, the processor being configured to obtain work-related information from the storage device, generate, based on the work-related information, an analysis target dataset that specifies a progress state of work and unexecuted work items, generate, based on the analysis target dataset and instruction content input by a user, model input information including a prompt sentence to be input to a generative AI model, input the model input information to the generative AI model, and acquire, from the generative AI model, an analysis result indicating a current progress state of the work and work items to be executed next, control, in correspondence with the work items included in the analysis result, a function of an external work support apparatus or work management apparatus to automatically execute at least one of schedule management, work registration, and notification transmission so as to execute the work in place of a human operator, record, in the storage device as history information, content of the work executed in place of the human operator and the progress state of the work, and hold the history information as work history referable by a successor, generate, based on the history information and the analysis result, summary information indicating a work outline for the successor and remaining work items, and output the summary information to a terminal device, and adjust, based on emotion analysis performed by an emotion analysis unit configured to recognize an emotion of the user, at least one of content and timing of presentation of the prompt sentence and the summary information so as to optimize a handover process and reduce a burden on the successor. This enables a technical improvement in computer-based handover management by providing an integrated, processor-implemented control loop in which work-related data are transformed into structured analysis targets, generative AI model prompts and outputs are used as machine-level control artifacts to drive external work support apparatuses, and user-facing information presentation is dynamically adapted based on emotion analysis, thereby enhancing operational continuity, reducing manual intervention, and improving the efficiency and reliability of work execution during personnel changes.

The term “work-related information” refers to data stored in one or more storage devices that describes operations of an organization, including but not limited to project information, task records, schedules, communication logs, handover documents, and activity histories associated with work.

The term “analysis target dataset” refers to a structured data representation generated from work-related information, which explicitly expresses at least a progress state of work and unexecuted work items in a form suitable for computational analysis.

The term “progress state of work” refers to an indication of a current stage or status of one or more work processes, including which tasks have been completed, which tasks are in progress, and which tasks have not yet been executed.

The term “unexecuted work items” refers to tasks or actions that are defined within work-related information but have not yet been carried out or completed at a given point in time.

The term “instruction content” refers to input information provided by a user that specifies a request, constraint, or objective for processing by the system, including but not limited to natural language instructions or parameter settings.

The term “model input information” refers to data that is prepared for input to a generative AI model, including at least one prompt sentence and optionally additional contextual information derived from an analysis target dataset and user instructions.

The term “prompt sentence” refers to a text string that is provided as input to a generative AI model to specify a task, context, or question, and that guides generation or inference performed by the generative AI model.

The term “generative AI model” refers to a machine learning model, typically based on a neural network such as a transformer, that generates output data including natural language text or structured data in response to input data including a prompt sentence.

The term “analysis result” refers to output information produced by the generative AI model in response to model input information, the output information including at least an indication of a current progress state of work and work items to be executed next.

The term “external work support apparatus” refers to a device or system that provides functionality to support business operations, including but not limited to schedule management systems, communication systems, and task management systems, which can be controlled via an interface by the processor.

The term “work management apparatus” refers to a device or system that maintains and updates information about tasks, projects, or workflows within an organization, and that can be programmatically controlled to register, modify, or complete work items.

The term “schedule management” refers to operations performed by the system to create, modify, or delete time-based events such as meetings, deadlines, or reminders in a scheduling system.

The term “work registration” refers to operations performed by the system to create or update representations of work items, such as tasks or issues, in a work management apparatus.

The term “notification transmission” refers to operations performed by the system to send messages or alerts to one or more recipients via communication channels, such as electronic mail, messaging services, or system notifications.

The term “history information” refers to data that records content of work executed by the system in place of a human operator and associated progress states of work, stored in a storage device for later reference.

The term “work history” refers to a subset of history information that provides a chronological or logically ordered record of actions, events, and states related to work operations, which can be referenced by a successor.

The term “summary information” refers to information generated from history information and analysis results that concisely describes a work outline, including key completed tasks and remaining work items, in a form understandable by a human user.

The term “terminal device” refers to an end-user computing device, such as a personal computer, tablet, or mobile device, that is configured to receive output from the server and present information to a user.

The term “emotion analysis unit” refers to a hardware or software component configured to recognize or estimate an emotional state of a user based on input data such as text, voice, or interaction patterns.

The term “emotion analysis” refers to processing performed by the emotion analysis unit to determine one or more emotional states of a user, such as stress, satisfaction, confusion, or overload, from user-related data.

The term “handover process” refers to a sequence of activities through which responsibilities, tasks, and related information about work are transferred from a current person in charge to a successor.

The term “successor” refers to a user who assumes responsibility for work previously handled by another person in charge, and who utilizes the system to understand past operations and remaining tasks.

The term “external interface” refers to a software or hardware mechanism, such as an application programming interface, through which the processor communicates with and controls an external work support apparatus or work management apparatus.

The term “in place of a human operator” refers to execution of work-related tasks by the system automatically, without requiring direct manual operation for each task by a human user.

In one embodiment, a server executes a program that implements the claimed system using a general-purpose processor, a memory device, a network interface, and one or more storage devices. The server is connected via a communication network to one or more terminal devices operated by users. The server uses an operating system such as a general-purpose server operating system, a database management system such as a relational database, a machine learning framework such as a neural-network framework, and an application framework such as a web application framework to realize the functions described below.

The server stores work-related information in one or more databases implemented on the storage device. The server uses a relational database system, for example, a database engine that supports structured query language, and defines tables such as a project table, a task table, a handover information table, and an activity log table. The server stores in these tables project identifiers, textual descriptions of tasks, timestamps, status codes, user identifiers, and links to external work support apparatuses.

The server uses an application program implemented in a general-purpose programming language running on an application framework to expose an application programming interface that the terminal accesses via a network protocol such as HTTPS. The server receives from the terminal data including a project identifier and instruction content from a user, for example a natural language instruction such as “Check the progress status of Project X and execute the next step.”

The server generates an analysis target dataset by executing data processing and data computation over the relational database. The server uses query statements to retrieve, for a given project identifier, a set of task records, including a task identifier, a textual description, a numeric status value, a planned start time, a planned end time, and a responsible user. The server merges these records into a structured in-memory data object that includes a list of completed tasks, a list of in-progress tasks, and a list of unexecuted work items. The server further attaches to this data object textual handover notes retrieved from the handover information table and event records retrieved from the activity log table.

The server converts the analysis target dataset into a text representation suitable as input context for a generative AI model. The server executes a deterministic transformation that maps each task record into a sentence with a fixed template, such as “Task [ID]: [summary text], status: [status label], deadline: [date].” The server concatenates such sentences in a pre-defined order, for example, sorted by deadline or by priority value, and combines them with a project overview section and a history summary derived from the activity log. The server thereby generates a context text that is machine-optimized for subsequent tokenization and inference. This structured textual encoding improves the ability of the generative AI model to identify dependencies and temporal ordering, thereby increasing the accuracy and stability of the analysis result.

The server generates model input information including a prompt sentence by concatenating a system directive, the context text, and the user's instruction content. For example, the server generates a prompt sentence such as:

“You are an AI assistant that manages business handover. Based on the following handover data and task history, identify the current progress of Project X and execute the next most appropriate step. Then describe the action you will take.”

The server appends, after this directive, the context text representing the analysis target dataset, and finally appends the user's explicit instruction such as “Check the progress status of Project X and execute the next step.” By systematically structuring the prompt sentence and its context, the server reduces token redundancy, improves inference speed, and stabilizes the generative output distribution of the generative AI model.

The server executes a generative AI model implemented as a neural network based on a transformer architecture, using a framework such as a neural network framework running either on one or more central processing units or one or more graphics processing units. The server uses a tokenizer specific to the generative AI model to convert the model input information into a sequence of token identifiers. The server stores these token identifiers in a tensor data structure and applies multi-head attention, feed-forward layers, layer normalization, and positional encoding operations as defined by the transformer architecture.

The server uses trained weight parameters stored in the storage device to compute, at each layer, matrix multiplications and non-linear activation functions over the token embeddings.

The server trains the generative AI model in advance using a supervised or semi-supervised learning process. During training, the server uses a loss function such as cross-entropy over predicted token sequences with respect to reference sequences representing correct analyses of work-related datasets. The server updates the model weights using an optimization algorithm such as stochastic gradient descent with adaptive learning rate. The server optionally performs data augmentation by artificially reordering task descriptions or paraphrasing instructions, thereby increasing robustness to variations in handover text. This training process teaches the model to map structured work-related context and prompt sentences to outputs that explicitly identify progress states and recommend next work items.

The server, during inference, decodes the output token sequence generated by the generative AI model into natural language text. The server optionally constrains the decoding process using a beam search algorithm or nucleus sampling with specified parameters to balance determinism and diversity. The server may instruct the model, via the prompt sentence, to output the analysis result in a semi-structured format, for example using labeled sections such as “Current Progress:” and “Next Actions:”. By standardizing this output format, the server simplifies downstream parsing, reduces parsing errors, and lowers the computational cost of extracting actionable information.

The server parses the analysis result using deterministic parsing rules. For example, the server uses pattern matching, regular expressions, or a lightweight rule-based parser to extract sections such as “Next Actions,” each including text describing a work item, a desired status, a proposed date, and a list of recipients. Because the server has shaped both the input prompt sentence and the expected output format, the parsing algorithm becomes efficient and robust, reducing the need for heavy post-processing logic and thereby reducing processor load and latency.

The server, based on the parsed analysis result, generates internal action descriptors. Each action descriptor is an in-memory object including fields such as action type, target resource identifier, parameters, and priority. The server maps the action type to specific external interfaces. For example, if an action descriptor indicates “schedule meeting,” the server uses an interface to a scheduling system, and if an action descriptor indicates “update task,” the server uses an interface to a work management apparatus. This mapping is stored as a configuration table in the storage device, and can be changed without modifying the core inference logic, which improves maintainability and extensibility.

The server controls an external work support apparatus or work management apparatus via external interfaces such as REST APIs, message queues, or remote procedure calls. The server sends requests to a scheduling system to create or modify calendar entries, including start times, end times, participants, and descriptions derived from the analysis result. The server sends requests to a task management system to create new tasks or update existing tasks with new statuses, deadlines, and assignees. By performing these operations automatically based on the structured analysis result, the server reduces the number of network round trips and minimizes redundant user interactions that would otherwise be required through multiple user interfaces.

The server records the actions executed in place of a human operator and the associated progress states as history information in the storage device. The server generates a compact history record that includes identifiers of external operations, timestamps, and summarized descriptions. The server uses an index structure within the database, for example a composite index on project identifier and timestamp, to accelerate retrieval of history information when generating future analysis target datasets. This indexing scheme reduces query latency and improves scalability when the number of history records grows over time.

The server generates summary information for a successor by querying the database for recent history information and by combining it with the latest analysis result from the generative AI model. The server applies a summarization process that may also be performed by a neural network-based model or by rule-based condensation logic. In one example, the server uses a second generative AI model or a specialized prompt sentence to transform detailed logs into a concise text such as:

“Project X is currently in the implementation phase. The following tasks have been completed: . . . . The following three tasks remain and are scheduled: . . . .”

By structuring the summarization pipeline, the server reduces information overload and provides a consistent, machine-generated handover document that is directly tied to the machine-executed history.

The server incorporates emotion analysis into the control loop by using an emotion analysis unit. The server receives user-related data from the terminal, such as text typed by the user, response times in the user interface, or optional voice signals captured by a microphone. The server extracts features such as lexical choice, typing speed, or prosodic patterns, and feeds these features into an emotion classification model implemented as a neural network trained to output an emotion label or continuous emotion score. The server uses these emotion scores to adjust the content and timing of prompt sentences and summary information. For example, when the server detects a high stress score, the server shortens the summary, highlights the most critical tasks, and delays non-urgent notifications. This adaptive behavior reduces cognitive load, shortens reading time, and increases the effectiveness of the handover communication.

The server improves computer technology in several ways. First, by representing work-related information as analysis target datasets with explicit progress states and by shaping prompt sentences and model outputs into semi-structured forms, the server reduces ambiguity and thereby lowers the error rate of generative AI outputs. This structure-aware prompting leads to fewer correction cycles, which reduces processor usage and network traffic. Second, by integrating the generative AI model directly into an action execution pipeline that controls external work support apparatuses, the server eliminates intermediate manual transcription steps and redundant fetch-and-confirm cycles that would otherwise be necessary. This leads to faster end-to-end processing, lower communication overhead, and more efficient resource utilization in distributed systems.

Third, the server applies non-conventional rules for transforming database records into model inputs and for parsing model outputs into executable actions. These rules are not simply automating human reading; they exploit the tokenization characteristics and attention mechanisms of transformer-based models by ordering and annotating context segments in ways that maximize inference stability. This yields higher prediction accuracy for next work items compared to naive text concatenation strategies, thus constituting an improvement in the functioning of the AI-based computing system itself.

Fourth, the server uses training and inference configurations that are tuned for the handover domain. The server uses domain-specific loss functions that penalize misalignment of predicted progress states with ground truth task graphs, and the server uses auxiliary tasks such as next-action classification during training to improve internal representations. These technical measures produce a generative AI model that converges faster during training and executes more efficiently at inference time, reducing computation per request.

The terminal operates as a user-facing device that sends user instructions and receives output. The terminal executes a client application that communicates with the server via a secure network protocol. The terminal sends to the server user inputs such as project identifiers and natural language instructions, and displays to the user the summary information and progress indicators received from the server. The terminal can display, for example, a list of AI-executed actions such as “A meeting with the client was scheduled for next Monday at 10:00” and “Task 123 was updated to In Progress,” together with the generated summary.

The user operates the terminal to initiate or refine the handover process. The user can issue different prompt sentences such as “Summarize completed tasks and list the top three pending tasks with recommended deadlines,” or “Identify any overdue tasks in Project X and automatically send reminder emails to the owners.” The server interprets these instructions via the generative AI model pipeline and updates the state of external work support apparatuses accordingly.

In alternative embodiments, the server may use different database technologies such as a document store or a graph database to represent relationships between tasks and projects. The server may use alternative neural network architectures, such as encoder-decoder architectures or recurrent networks, instead of or in addition to transformer-based models.

The server may also partition the generative AI processing across multiple machines using a distributed training or inference framework to handle large volumes of work-related data.

In another embodiment, the server may execute the emotion analysis unit on the terminal, with the terminal performing initial feature extraction from audio or video and then sending only compact emotion scores to the server, thus reducing network bandwidth usage and preserving privacy. In yet another embodiment, the server may cache intermediate analysis results and history-based summaries for frequently accessed projects, thereby reducing repetitive computations and improving response time for successive queries from successors.

By combining these elements, the server provides a concrete computer-implemented mechanism that goes beyond simple automation of human analysis. The server changes the way work-related data is encoded, processed, and acted upon by computing machinery, improves the internal functioning of the generative AI model through structured prompting and specialized training, and realizes a closed-loop control system over external work support apparatuses with adaptive, emotion-aware presentation logic. This results in measurable technical effects, including improved inference accuracy, reduced latency, lowered computational load, and more efficient use of communication and storage resources.

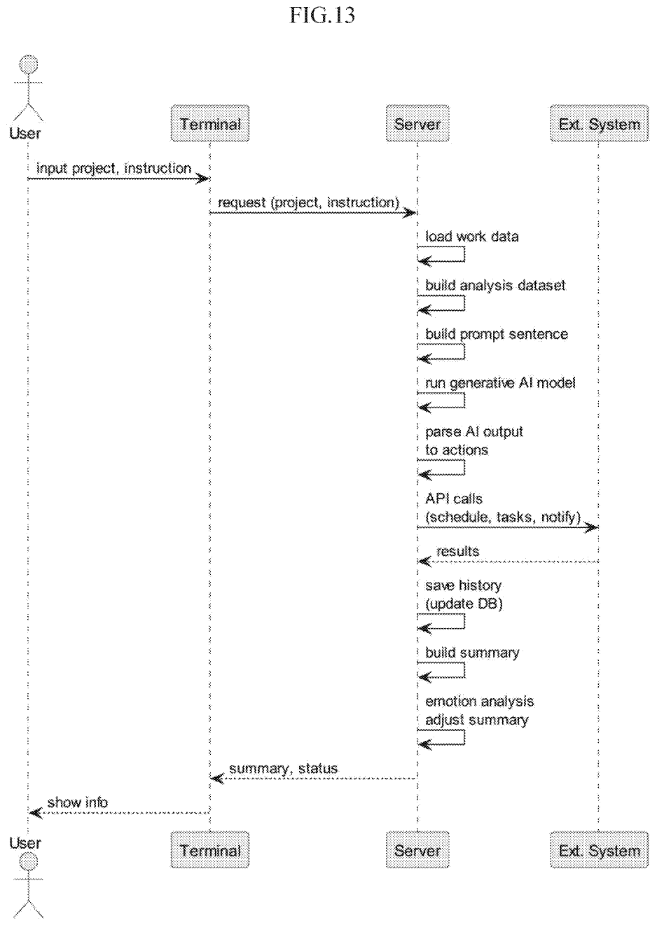

The following describes the processing flow using FIG. 13.

### Step 1:

The user operates the terminal to specify a target project and an instruction.

The user inputs, via a user interface on the terminal, a project identifier and a natural language instruction such as “Check the progress status of Project X and execute the next step.”

Input: The terminal receives from the user the project identifier, a user identifier, and an instruction string.

Processing: The terminal validates the input format locally (for example, checks that the project identifier is not empty) and packs these values into a request object.

Output: The terminal generates a structured request (for example, a JSON object containing project_id, user_id, and instruction) and prepares it for transmission to the server.

### Step 2:

The terminal transmits the request to the server over a network.

The terminal sends the structured request via a secure protocol such as HTTPS to an application endpoint exposed by the server.

Input: The terminal uses the request object generated in Step 1.

Processing: The terminal serializes the request object into a network message, opens a network connection to the server's address, and attaches authentication tokens if available.

Output: The terminal outputs an HTTP request containing the project identifier, user identifier, and instruction content to the server.

### Step 3:

The server receives and authenticates the request from the terminal.

The server accepts the HTTP request through a web server and passes it to an application handler.

Input: The server receives the HTTP request message containing project_id, user_id, and instruction content.

Processing: The server parses the HTTP headers and body, extracts the JSON payload, verifies the user's authentication token, and performs basic schema validation on the fields (e.g., checks that project_id matches an allowed pattern).

Output: The server generates an internal request context object that includes validated project_id, user_id, instruction content, and a timestamp.

### Step 4:

The server retrieves work-related information from the storage device.

The server issues database queries to obtain all records related to the specified project.

Input: The server uses the project_id from the request context object.

Processing: The server executes query statements against a relational database to retrieve project metadata, task records (including status and deadlines), handover notes, and past actions from an activity log table. The server then groups and orders these records by task status, priority, and time.

Output: The server produces a structured in-memory dataset representing the work-related information, including lists of completed tasks, in-progress tasks, and unexecuted work items, together with associated textual descriptions and timestamps.

### Step 5:

The server constructs an analysis target dataset.

The server transforms raw database records into a normalized internal structure optimized for subsequent AI processing.

Input: The server uses the structured work-related dataset generated in Step 4.

Processing: The server maps each task record into a standardized object schema (for example, fields for task_id, normalized status code, normalized deadline, and cleaned text summary).

The server also merges handover notes and activity history into dedicated fields within the dataset, and removes duplicate or obsolete entries by comparing timestamps and status values.

Output: The server generates an analysis target dataset that explicitly represents the current progress state of work and the unexecuted work items in a machine-friendly structure.

### Step 6:

The server generates a context text from the analysis target dataset.

The server encodes the structured data into a deterministic textual representation.

Input: The server uses the analysis target dataset from Step 5.

Processing: The server iterates over task objects and applies a fixed template to each, creating sentences such as “Task 123: Implement feature A, status: in-progress, deadline: 2025 Jun. 30.” The server concatenates these sentences into sections (completed, in-progress, pending) and prepends a project overview sentence derived from project metadata.

Output: The server outputs a context text string that summarizes the project state in a consistent, ordered format.

### Step 7:

The server composes a model input including a prompt sentence.

The server builds the text that will be sent to the generative AI model.

Input: The server uses the context text from Step 6 and the user's instruction content from Step 3.

Processing: The server first prepares a system directive such as “You are an AI assistant that manages business handover. Based on the following handover data and task history, identify the current progress and the next most appropriate step.” The server then concatenates the system directive, the context text, and the user's instruction, for example “Check the progress status of Project X and execute the next step.”

Output: The server generates a complete prompt sentence (or prompt text block) that constitutes the model input information for the generative AI model.

### Step 8:

The server tokenizes the prompt text for input to the generative AI model.

The server converts the prompt sentence into a sequence of token identifiers.

Input: The server uses the prompt text generated in Step 7.

Processing: The server applies a tokenizer associated with the generative AI model. The tokenizer splits the text into tokens, maps each token to an integer identifier, and constructs an array (or tensor) of token identifiers with positional indices.

Output: The server produces a token sequence and associated positional information suitable for the generative AI model's input layer.

### Step 9:

The server performs inference using the generative AI model.

The server runs the neural network to derive an analysis result.

Input: The server uses the token sequence from Step 8.

Processing: The server loads model parameters into memory and applies transformer layers, including attention mechanisms, feed-forward operations, and normalization. The server computes, layer by layer, probability distributions over possible next tokens. The server then decodes an output sequence using, for example, beam search or nucleus sampling with preset parameters.

Output: The server generates an output text produced by the generative AI model that includes at least a description of the current progress state and recommended next work items.

### Step 10:

The server parses the generative AI model's output into structured actions.

The server converts the natural language output into internal action descriptors.

Input: The server uses the output text from Step 9.

Processing: The server applies parsing rules, such as regular expressions or section markers (e.g., “Next Actions:”), to identify individual recommended actions. For each action, the server extracts an action type (e.g., schedule meeting, update task), parameters (e.g., date, participants, task identifiers), and any constraints.

Output: The server produces a list of internal action descriptor objects, each representing an action that can be executed by controlling external work support apparatuses.

### Step 11:

The server maps action descriptors to external systems and prepares control requests.

The server determines which external apparatus should perform each action.

Input: The server uses the list of action descriptors from Step 10.

Processing: The server consults a configuration mapping that associates action types with specific external services, such as a scheduling system or a task management system. For each action, the server constructs an API request payload that includes required parameters, converts timestamps into the external system's expected format, and sets authentication headers.

Output: The server generates a list of API request objects that are ready to be sent to the corresponding external work support apparatuses.

### Step 12:

The server executes automatic control of external work support apparatuses.

The server sends the prepared requests and receives responses.

Input: The server uses the API request objects from Step 11.

Processing: The server transmits each request to the appropriate external endpoint using network calls. For example, the server calls a scheduling system to create a calendar entry or calls a task management system to update task status. The server measures response times, checks HTTP status codes, and parses response bodies to confirm success or detect errors.

Output: The server outputs a set of execution results, each including success/failure status, external resource identifiers (e.g., event IDs, task IDs), and any error messages.

### Step 13:

The server records execution and progress information as history.

The server updates the database to reflect operations performed in place of a human.

Input: The server uses the execution results from Step 12 and the current progress state derived from the analysis result in Step 9.

Processing: The server generates history records with fields such as project_id, action_type, executed_by (AI), timestamps, external resource identifiers, and summary text. The server executes insert or update statements to store these records in the activity log table and, if necessary, adjusts task status fields in the task table to align with executed operations.

Output: The server produces updated database tables containing a persistent work history and an updated representation of overall progress.

### Step 14:

The server generates summary information for a successor.

The server synthesizes a concise description of the work state and remaining items.

Input: The server uses the updated history information from Step 13 and the analysis result from Step 9.

Processing: The server selects recent key events from the history, identifies remaining unexecuted tasks, and composes a human-readable summary. The server may optionally call a summarization routine or a specialized generative AI prompt to transform granular logs into a short narrative such as “The system scheduled a client meeting for next Monday and marked three tasks as in progress; two high-priority tasks remain.”

Output: The server generates summary information text describing the work outline and remaining tasks.

### Step 15:

The server applies emotion analysis to adjust presentation content and timing.

The server adapts what and when to present based on recognized user emotion.

Input: The server uses user-related data (for example, recent input text or interaction patterns) received from the terminal and processed emotion scores from an emotion analysis unit.

Processing: The server evaluates the emotion score to determine if the user or successor is stressed, overloaded, or calm. Based on thresholds, the server selects a presentation profile, such as “compact summary with only top three next actions” or “detailed summary with full history.” The server also decides whether to delay non-urgent notifications.

Output: The server produces an adjusted summary text and a presentation schedule that reflects the emotion-aware decisions.

### Step 16:

The server sends the final summary and status information to the terminal.

The server transmits the information that the successor will read.

Input: The server uses the adjusted summary text and the current progress data from Step 14 and Step 15.

Processing: The server constructs a response object containing the summary text, lists of completed and pending tasks, and information about actions taken automatically. The server serializes this object into a network message and attaches metadata such as response timestamp and project identifier.

Output: The server outputs an HTTP response to the terminal containing the summary and status information.

### Step 17:

The terminal displays the summary and action log to the user.

The terminal renders the received data on the user interface.

Input: The terminal receives the HTTP response from the server, including summary text and task lists.

Processing: The terminal parses the response, updates internal view models, and redraws the user interface components. The terminal shows, for example, a textual summary, a list of pending tasks, and a log of AI-executed actions. The terminal may also highlight actions that were triggered by specific prompt sentences such as “Check the progress status of Project X and execute the next step.”

Output: The terminal presents the updated information on a display so that the user or successor can understand the current work state and the automatically executed operations.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional work-handover support systems typically treat business data analysis, content generation, and user interaction as separate, loosely coupled functions. As a result, such systems often (i) rely on static templates or manually crafted documents, (ii) fail to incorporate the actual operational context contained in large-scale work logs and sensor streams, and (iii) ignore the emotional state of human users who are under stress during handover or task transition. This architecture leads to several technical problems.

First, conventional systems usually process work logs and incident records with simple rule engines or offline analytics, and then separately generate handover documents. Because these components are not integrated with a generative AI model that can dynamically utilize the full historical and real-time context, the resulting outputs are either overly generic or excessively verbose. From a computer-technology perspective, this separation wastes the expressive capacity of modern sequence models, forces redundant data movement between modules, and prevents the system from generating optimized, task-specific representations at inference time.

Second, known systems typically send raw or minimally processed user queries to language models without constructing a structured, context-enriched prompt sentence. In such architectures, the central processing unit cannot systematically retrieve and combine relevant subsets of work data (for example, specific logs, tasks, or incident histories) with the user's current intent. Consequently, the model input is information-poor, leading to suboptimal responses and requiring repeated queries. This results in increased processor load, unnecessary network traffic to external AI services, and inefficient use of computing resources.

Third, most existing solutions do not include any feedback loop that adjusts the behavior of the generative AI model and the prompt generation logic based on user emotion and interaction outcomes. The absence of an emotion engine tightly integrated with the core control flow forces the system to present the same volume and structure of information to all users, regardless of their stress level, confusion, or confidence. This lack of adaptation not only degrades user experience, but also leads to technical inefficiencies, such as repetitive interactions, correction cycles, and excessive rendering of unneeded content on terminal devices, which in turn increases processing overhead on both server and client.

Fourth, existing handover platforms treat worker absence, task reassignment, and work continuation as purely organizational issues rather than as problems of runtime computation and scheduling. They do not use generative AI outputs to dynamically reprioritize machine-executable tasks and generate continuation procedures suitable for automatic processing apparatuses. This prevents a server from programmatically converting model outputs into structured control decisions that can be executed by downstream systems, which limits the ability of the computing system to maintain stable operation under personnel changes.

Therefore, there is a need for a technical solution that (i) integrates acquisition and preprocessing of work-related information, (ii) constructs and enriches prompt sentences with context, (iii) drives a generative AI model in a closed loop with an emotion engine, and (iv) uses the resulting responses to automatically adjust task priorities and work assignments.

Such a solution should improve the efficiency and effectiveness of the underlying computing system itself, by reducing unnecessary computation and communication, by optimizing the structure and amount of information presented to users, and by enabling context-aware, emotion-aware control of work continuation and handover processes.

The specific processing by the specific processing unit 290 of the data processing device 12 in Application Example 2 is realized by the following means.

The present invention provides a server comprising a processor configured to acquire and preprocess work-related information into training information, to build or update a generative AI model using a machine learning framework on the basis of the training information, to control a terminal device to generate a prompt sentence including a work procedure or a handover request based on an operation history or a selection content of a user, to acquire related work information corresponding to the prompt sentence from an information storage device and append the related work information to the prompt sentence so as to create input information for the generative AI model, to input the input information for the generative AI model to the generative AI model and obtain response information including work procedure information or handover information from the generative AI model, to use an emotion engine that specifies an emotional state of the user from user information or text information and adjust at least one of an information amount, a presentation order, and a detail level of the prompt sentence or the response information in accordance with the emotional state, to generate a handover document, work instruction information, or work support information on the basis of the response information and cause the terminal device to output the handover document, the work instruction information, or the work support information, to reset a priority of work in accordance with an absence or a load state of a worker and determine work assignment or work continuation processing to an automatic processing apparatus or another worker by using the response information, and to update at least one of a generation rule of the prompt sentence and training data of the generative AI model on the basis of feedback information from the terminal device so as to continuously optimize a work handover process. This enables the computing system to dynamically construct context-enriched model inputs, to adapt the structure and volume of generated outputs to user emotion in real time, to automatically derive executable continuation and reassignment decisions from generative AI responses, and to iteratively improve its own prompt generation and model behavior based on operational feedback, thereby improving the efficiency, robustness, and responsiveness of computer-based work handover and continuation processing.

The term “work-related information” refers to data representing activities, states, or events in an operational environment, including but not limited to task records, operation logs, sensor readings, incident reports, schedule information, and user interaction histories, which are used by the system to analyze, support, or continue work processes.

The term “training information” refers to data obtained by preprocessing work-related information into a format suitable for machine learning, including cleaned, normalized, and structured datasets such as tokenized text sequences, time-series feature vectors, and labeled examples used to build or update a model.

The term “machine learning framework” refers to a software platform or library that provides functions for defining, training, evaluating, and executing machine learning models, including operations such as model construction, parameter optimization, and inference on computing hardware.

The term “generative AI model” refers to a machine learning model that, in response to an input such as a prompt sentence and optional context data, generates output data including natural language text, sequences of actions, or structured recommendations, based on patterns learned from training information.

The term “terminal device” refers to an information processing apparatus operated by a user, such as a computing device with an input interface and an output interface, which communicates with the server to send user inputs, receive system outputs, and present information to the user.

The term “prompt sentence” refers to a natural language expression or equivalent structured input that specifies a request, condition, or context for the generative AI model, and that is used as model input to obtain generated output related to work procedures, handover content, or other operational support.

The term “operation history” refers to a record of past actions or interactions performed by a user or device, including task selections, commands, confirmations, and navigation events, which is used by the processor to infer user intent and generate appropriate prompt sentences.

The term “selection content” refers to information indicating choices made by a user via a user interface, such as selected task types, target systems, priority options, or configuration parameters, which are incorporated into prompt sentences or control logic.

The term “information storage device” refers to a storage resource, such as a memory system, database system, or file system, that stores work-related information, training information, or other data, and that can be accessed by the processor to retrieve related work information.

The term “related work information” refers to a subset of work-related information that is selected based on its relevance to a given prompt sentence, such as logs, documents, tasks, or incident records associated with specified entities, time ranges, or identifiers.

The term “input information for the generative AI model” refers to data provided to the generative AI model, including at least a prompt sentence and any appended related work information, optionally encoded or formatted according to model requirements, for use in generating response information.

The term “response information” refers to output data generated by the generative AI model in response to input information for the generative AI model, including but not limited to work procedure information, handover information, summaries, recommendations, and predicted actions.

The term “emotion engine” refers to a functional component that receives user-related data such as images, audio, or text, applies an emotion analysis program or emotion recognition service, and determines an emotional state or related metrics describing the user's affective condition.

The term “user information” refers to data obtained from or about a user, including visual information, audio information, textual input, or interaction logs, which can be used by the emotion engine or other modules to infer user state or intent.

The term “text information” refers to character-based data such as typed input, transcribed speech, or extracted text from documents, which can be processed by natural language analysis or emotion analysis functions.

The term “emotional state” refers to a classification or representation of a user's affective condition, such as stress, anxiety, calmness, joy, anger, fear, hope, or satisfaction, as determined by the emotion engine from user information or text information.

The term “information amount” refers to a quantitative or qualitative measure of the volume of information included in a prompt sentence or response information, such as number of items, length of text, or granularity of detail.

The term “presentation order” refers to the sequence in which elements of information, such as steps, sections, or items, are displayed, spoken, or otherwise presented to a user on the terminal device.

The term “detail level” refers to a parameter indicating the depth and specificity of information provided, including whether information is presented as a high-level summary, intermediate description, or fine-grained, step-by-step explanation.

The term “handover document” refers to structured content that aggregates and organizes information necessary for transferring responsibility of work from one worker to another, including overviews, pending tasks, risks, and relevant references.

The term “work instruction information” refers to information that specifies operations to be performed in a work process, including ordered steps, conditions, cautions, and parameters required to execute tasks.

The term “work support information” refers to supplementary information that assists a user in performing or understanding work, such as recommendations, context summaries, predicted problems, and mitigation strategies.

The term “automatic processing apparatus” refers to a device or system capable of executing tasks automatically according to control data, such as an industrial machine, a robot, or a software service that performs processing without continuous human intervention.

The term “load state of a worker” refers to information indicating a worker's workload or capacity, such as number of assigned tasks, task urgency, temporal constraints, or inferred burden based on system metrics or emotion analysis.

The term “priority of work” refers to an order or weighting assigned to tasks or work items that determines their relative importance, execution order, or resource allocation preference within the system.

The term “work assignment” refers to a decision or mapping that associates specific tasks or work items with a responsible entity, such as a particular worker or an automatic processing apparatus.

The term “work continuation processing” refers to a set of operations performed by the system to maintain progress of tasks when circumstances change, including generating continuation procedures, reassigning tasks, and issuing control commands or instructions.

The term “feedback information” refers to data representing a user's evaluation, correction, or interaction outcome related to system outputs, including explicit ratings, edits, comments, or implicit behavior logs, which are used to adjust system behavior.

The term “generation rule of the prompt sentence” refers to a set of conditions, templates, or algorithms that determine how a prompt sentence is constructed from inputs such as operation history, selection content, context data, and emotion state.

The term “training data of the generative AI model” refers to the collection of examples, including input-output pairs, context-enriched prompts, and corrected responses, that are used to train, fine-tune, or adapt the generative AI model.

The term “work handover process” refers to a sequence of operations by which knowledge, tasks, and responsibilities are transferred from one worker to another or to an automatic processing apparatus, including collection, analysis, generation, presentation, and confirmation of handover-related information.

The term “input information for the generative AI model for a worker change” refers to the subset of input information used when a worker is replaced due to retirement, transfer, or temporary absence, including prompt sentences and associated context specific to that change event.

The term “continuation procedure” refers to a description of steps and conditions necessary to continue unfinished work when responsibility is shifted, including which tasks to perform, in what order, and under what constraints.

The term “handover instruction information” refers to information specifically formatted as directives or guidelines for a substitute worker or automatic processing apparatus, derived from response information and structured for execution or follow-up.

The term “history information” refers to accumulated records of past operations, events, or system states, such as logs of completed tasks, configuration changes, and interactions over time.

The term “failure information” refers to data describing error events, malfunction incidents, or abnormal conditions, including timestamps, affected components, error messages, and resolution steps.

The term “future problem event” refers to a predicted or potential issue that may occur in a work environment, as estimated by the generative AI model based on history information and failure information.

The term “countermeasure procedure” refers to a set of actions, steps, or guidelines recommended to prevent or mitigate a future problem event, including diagnostics, configuration changes, and operational adjustments.

Server implements the invention as software modules executed on one or more information processing devices equipped with at least one processor, a main memory, a non-volatile storage device, and a communication interface. Server may be realized by a rack-mounted computing device including a multi-core central processing unit, an optional graphics processing unit, and a network interface controller. Server stores executable programs and configuration data in a storage device such as a magnetic storage device or a solid-state storage device and loads them into main memory at runtime.

Server uses a machine learning framework such as a tensor computation framework or a deep learning library to construct, train, and execute a generative AI model. Server implements the generative AI model as a sequence-to-sequence neural network including an encoder part and a decoder part. In one embodiment, server uses a transformer-based architecture having multiple self-attention layers, each attention layer computing scaled dot-product attention over token embeddings. Server represents each token in a prompt sentence or related work information as a dense vector of fixed dimensionality (for example, 512 or 1024 dimensions), and server applies positional encodings to preserve order information in the input sequence.

Server configures the neural network with a plurality of parameters (weights and biases), which are stored as multidimensional arrays in system memory. Server initializes these parameters using a standard distribution and updates them by stochastic gradient descent or a variant such as Adam optimization. Server defines a loss function appropriate to the task, for example, a cross-entropy loss for next-token prediction. Server computes gradients of the loss with respect to model parameters using automatic differentiation provided by the machine learning framework and applies weight updates in mini-batch fashion. Server may perform data augmentation by randomly masking tokens, shuffling non-critical sections, or adding synthetic noise to time-series features so that the generative AI model becomes robust to incomplete or noisy work-related information.

Server acquires work-related information from various data sources. Server obtains textual work logs, incident descriptions, and tickets from a data management system using structured queries. Server obtains time-series measurements, such as sensor values from an industrial apparatus, through a communication protocol such as a publish-subscribe protocol or an industrial automation protocol. Server maps this work-related information into standardized data structures, for example, records with fields such as task identifier, timestamp, worker identifier, apparatus identifier, and serialized content. Server then preprocesses this data to generate training information. For textual data, server performs tokenization, lowercasing, and normalization of technical terms. For time-series data, server segments continuous streams into fixed-length windows, computes derived features (for example, moving averages, standard deviations, and frequency-domain features), and stores these as feature vectors.

Server uses this training information to train the generative AI model so that the model learns relationships between work context and appropriate outputs, such as work procedures, handover summaries, or predicted problem events. Server may construct separate heads or output layers for different tasks (for example, one head for generating textual instructions and another head for predicting labels such as “high risk” or “low risk”). By integrating multiple tasks, server enables parameter sharing across related subtasks and improves generalization performance.

Terminal serves as a user interface device that interacts with server. Terminal may be implemented as a portable computing device, a desktop computing device, or an embedded interface attached to an industrial apparatus, including a display, an input interface such as a touch panel or keyboard, a microphone, and optionally a camera. Terminal executes a user-interface program that allows user to issue requests, review generated information, and provide feedback. Terminal sends user selections, typed inputs, and audio or visual data to server via a communication network.

User operates terminal to select a use case (for example, handover preparation, task guidance, or problem prediction) and to enter minimal parameters such as a project identifier, an apparatus identifier, or a desired granularity of explanation. Terminal converts these interactions into structured interface messages and transmits them to server. Terminal may also display intermediate results, such as candidate prompt sentences, and allow user to edit or confirm these sentences before they are sent to server.

Server generates a prompt sentence based on user inputs and operation history. Server maintains a generation rule of the prompt sentence, which is a set of templates and transformation rules that map structured data (use-case type, identifiers, time ranges, and emotion state) into a natural language expression. For example, server may generate the following prompt sentences:

“Explain the step-by-step procedure for assembling part A and part B on the designated apparatus, including safety checks and inspection criteria.”

“Analyze the last six months of work logs for worker X and extract the key handover items for the successor, grouped into open tasks, known risks, and important contacts.” “Using the following list of open tickets and incident records, create a structured handover summary for the successor responsible for system Y.”

“Predict potential failures from the following vibration and temperature data for the apparatus and propose maintenance actions.”

“Generate a concise checklist of the five most critical handover items for project Z that the successor must know today, considering that the current user is under high stress.” Server does not merely pass these prompt sentences directly to the generative AI model.

Server first retrieves related work information corresponding to the prompt sentence from an information storage device. For instance, when the prompt sentence references worker X, server executes a query over the storage device to obtain all work logs, documents, and incident records associated with that worker within a relevant time window. Server then encodes this related work information in a compact form. For textual information, server may extract salient sentences by using term-frequency or embedding similarity metrics, and server may limit the total token count based on a model-specific maximum length. For numeric sequences, server may generate summary statistics or discretized representations.

Server then appends the related work information to the prompt sentence according to a structured format, such as:

“Context: [list of summarized work logs, incidents, and key parameters]. Instruction: [prompt sentence]. Output format: [desired section headings and bullet format].”

Server thus creates input information for the generative AI model that includes both the user instruction and machine-selected context. This design differs from simple human-constructed prompts, because server automatically determines which records to include and how to order them in order to maximize model effectiveness while controlling input size. As a result, server reduces redundant off-target content and decreases computational load while increasing output accuracy.

Server obtains response information by executing the generative AI model on the input information for the generative AI model. In an embodiment, server runs inference using a transformer decoder that produces a sequence of tokens, each generated from the previous tokens and the encoder outputs representing the prompt and context. Server stops generation when the model outputs an end-of-sequence symbol or reaches a predefined length. Server may also compute confidence scores or log probabilities for parts of the output and use these metrics to flag uncertain sections for user review.

Server includes an emotion engine that processes user information to determine an emotional state. Terminal captures user's facial images via the camera and voice via the microphone.

Terminal may convert voice into text by speech recognition software. Terminal then transmits these data to server. Server feeds images and audio or text into an emotion analysis program or emotion recognition service. In one embodiment, server uses a convolutional neural network trained on facial expression data to generate a probability distribution over emotion classes. In another embodiment, server uses a recurrent neural network or a transformer on textual transcript to estimate sentiment scores. Server aggregates these outputs into an emotional state representation, such as a vector indicating stress, anxiety, calmness, and confidence levels.

Server uses the emotional state as a control parameter for both prompt generation and output post-processing. For example, when the emotional state indicates high stress or fear, server adjusts the generation rule of the prompt sentence to request concise outputs:

“Provide a concise checklist of the three most critical steps required to safely complete the current task.”

Conversely, when the emotional state indicates calmness or high confidence, server may adjust the rule to request more detailed, reflective outputs:

“Provide a detailed explanation of the task performance, including lessons learned, optimization suggestions, and potential future risks.”

Server also uses the emotional state to decide how to present response information. When terminal receives a long response text, server may reorder items so that the highest priority or safety-related information appears first. Server may also truncate or collapse less important sections into summaries and allow terminal to expand them on demand. This emotion-aware control reduces cognitive load and interaction time, which improves overall system efficiency.

Server generates a handover document, work instruction information, or work support information from response information. Server parses the generated text by recognizing structural markers such as headings, enumerations, and keywords. Server then maps content into a structured document format, such as a hierarchical section tree. Server may apply additional natural language processing functions to remove redundancy, detect inconsistencies, and align terminology with internal standards. Server stores the resulting documents in a storage device and registers metadata, such as responsible worker, system identifier, date, and emotion state at generation time.

Terminal retrieves and displays these documents to user. Terminal may show an overview panel with key sections (for example, “Overview”, “Open Tasks”, “Risks”, “Key Contacts”) and allow user to navigate by tapping. Terminal may also convert text to speech via an audio synthesis module, which is particularly effective in industrial environments where user cannot look at a screen continuously. By structuring the content according to server's decisions, terminal avoids unnecessary rendering of irrelevant data, thus reducing local resource use.

Server additionally uses response information to control task priorities and work assignment.

Server receives information about worker absence and load state from scheduling systems or monitoring modules. For example, when a worker is temporarily absent, server identifies that worker's unfinished tasks by querying the work management data. Server then generates a continuation procedure by constructing a prompt sentence such as:

“Worker A is unavailable. Using the following list of open tasks and system states, propose a plan to continue these tasks automatically or reassign them. Prioritize tasks critical to operational continuity.”

Server combines this prompt with context data describing tasks, apparatus states, and deadlines, and passes the input information for the generative AI model to the generative AI model. Response information may contain a recommended mapping of tasks to substitute workers or to automatic processing apparatuses, as well as step-by-step instructions. Server converts these recommendations into concrete control actions, such as issuing control messages to an automatic processing apparatus to start or stop specific operations or updating assignment records in a task management database. Because server computes these assignments by jointly evaluating context and learned patterns, and not merely by applying static rules, server can achieve improved resource utilization and reduced downtime.

Server receives feedback information from terminal indicating how user interacted with generated outputs. Feedback information may include explicit ratings (“useful”, “too long”), edits to generated documents, or behavior logs indicating which sections were read or skipped. Server uses this feedback information to update the generation rule of the prompt sentence, for example by reducing default length or adding explicit output format constraints.

Server may also incorporate corrected outputs as new training data for fine-tuning the generative AI model. In this way, server implements a closed loop where the system gradually adapts to the organization-specific language, workflows, and user preferences.

This architecture produces technical effects that go beyond mere automation of human document drafting. First, by programmatically constructing context-enriched input information for the generative AI model, server reduces the number of interactions and retries required to obtain satisfactory outputs. This reduces network traffic and computational load for model inference and accelerates overall processing. Second, by using an emotion engine to adapt the information amount, presentation order, and detail level, server reduces unnecessary generation and display of irrelevant detail, which decreases memory consumption and processor usage on both server and terminal. Third, by decoding generative outputs into structured continuation procedures and control commands for automatic processing apparatuses, server improves real-time task scheduling and apparatus utilization, which is a technical improvement in system control rather than a mere business process.

In one alternative embodiment, server uses a recurrent neural network or a hybrid of recurrent and attention mechanisms instead of a pure transformer architecture. In another embodiment, server deploys multiple generative AI models specialized for different domains (for example, maintenance vs. software operations) and selects the appropriate model according to the prompt sentence and identifiers. In yet another embodiment, server implements compression of related work information by using a smaller embedding model or clustering algorithm before including it in input information for the generative AI model, thereby further reducing input size and inference time.

Terminal may vary in configuration. In an industrial setting, terminal may be integrated with an apparatus controller and may display instructions on a ruggedized touch screen while receiving status information directly from sensors. In an office setting, terminal may be a browser client running on a general-purpose computing device. In each case, server maintains the same logical data flow: from work-related information, through training information and prompt sentence generation, to emotion-aware model control and output structuring.

User benefits from this system because user receives handover documents and work instructions that are automatically tailored to the operational context and personal emotional state, but the underlying contribution resides in how server orchestrates data structures and algorithms to achieve higher computational efficiency and prediction accuracy. By tightly coupling the generative AI model, the emotion engine, the prompt generation module, and the task assignment module, server transforms raw logs and signals into actionable guidance and control decisions in a way that conventional static systems cannot realize.

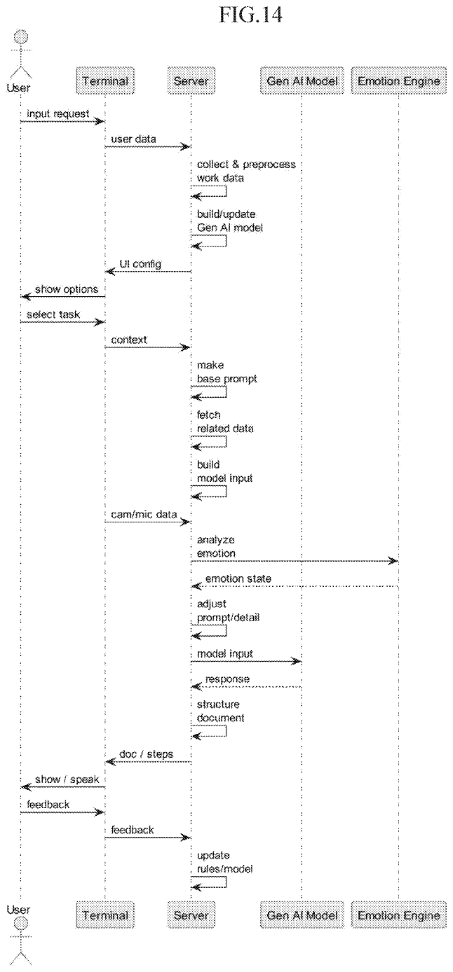

The following describes the processing flow using FIG. 14.

### Step 1:

Server acquires raw work-related information.

Server receives as input work logs, incident records, sensor streams, schedule data, and user interaction histories from data sources such as a data management system and an apparatus controller. Server performs data ingestion operations such as issuing structured queries, subscribing to message topics, and reading log files. Server normalizes identifiers (for example, worker IDs, apparatus IDs), attaches timestamps, and stores the aggregated records in a storage device as raw work-related information. The output of this step is a collection of structured records representing unprocessed work-related information.

### Step 2:

Server preprocesses the work-related information into training information.

Server receives as input the raw work-related information from storage. Server applies data cleaning operations such as removal of duplicate entries, correction of invalid timestamps, and normalization of textual fields. Server performs data transformations including tokenization of text fields, segmentation of continuous time-series data into fixed-length windows, and computation of derived features such as moving averages and standard deviations for each window. Server then packages these transformed data elements into training examples, each example pairing an input context (for instance, logs plus metadata) with a desired output label or text where available. The output of this step is training information stored in a format suitable for machine learning, such as arrays of numerical feature vectors and token sequences.

### Step 3:

Server trains or updates the generative AI model.

Server receives as input the training information from Step 2. Server uses a machine learning framework to construct a neural network architecture having an encoder and a decoder with multiple attention layers. Server feeds mini-batches of training examples into the model, computes a loss value such as cross-entropy between predicted tokens and target tokens, and applies gradient-based optimization to update model parameters. Server repeats this process for multiple training epochs and periodically evaluates accuracy and loss on validation data to determine convergence. Server then saves the learned model weights and configuration to storage. The output of this step is a trained generative AI model ready for inference.

### Step 4:

Terminal collects user inputs and operation history.

Terminal receives as input explicit actions from user, such as menu selections, task choices, typed text, and button presses, while user interacts with a graphical interface. Terminal logs these actions with timestamps and contextual information (for example, which screen was active, which task ID was selected). Terminal stores this log locally and periodically transmits the operation history to server via a communication interface. Terminal also forwards specific user-provided parameters such as worker ID, project ID, or desired detail level. The output of this step is a set of structured user input messages and operation history records transmitted to server.

### Step 5:

Server generates a base prompt sentence using templates and user context.

Server receives as input the user inputs and operation history from Step 4. Server analyzes the operation history to infer the requested use case (for example, “handover summary” vs. “task guidance”) and extracts parameters such as the target worker, apparatus, or time span. Server applies prompt-generation rules that map these parameters into natural language templates.

For example, server may generate:

“Explain the step-by-step procedure for assembling part A and part B on the designated apparatus, including safety checks and inspection criteria.” or

“Analyze the last six months of work logs for worker X and extract the key handover items for the successor, grouped into open tasks, known risks, and important contacts.”

Server outputs a base prompt sentence that encodes the user's request in natural language form.

### Step 6:

Server acquires related work information and builds model input information.

Server receives as input the base prompt sentence from Step 5 and the stored work-related information from Step 1. Server parses the base prompt sentence to extract referenced entities such as worker identifiers, apparatus identifiers, and time ranges. Server then executes queries over the storage device to retrieve related work information that matches these entities, such as all work logs, incident records, and sensor summaries for a given worker within a specified period. Server performs data reduction operations, including selecting representative records, computing summary statistics, and extracting salient sentences using text similarity or term-frequency metrics. Server then concatenates the base prompt sentence with a formatted representation of the related work information to create input information for the generative AI model, for instance by constructing a text block with sections

“Context:” and “Instruction:”. The output of this step is a compact yet context-rich input payload for the generative AI model.

### Step 7:

Terminal acquires user emotion-related data.

Terminal receives as input real-time signals from a camera and a microphone while user interacts with the interface. Terminal may apply local pre-processing such as downsampling video frames and compressing audio segments. Terminal optionally performs speech recognition to convert spoken content into text. Terminal packages the visual frames, audio features, and text into a message and transmits this user information to server. The output of this step is a user information packet that can be analyzed for emotion.

### Step 8:

Server determines an emotional state by using an emotion engine.

Server receives as input the user information from Step 7. Server forwards facial images to an image-analysis module or service, which computes probabilities for emotion categories based on facial landmarks and expression features. Server forwards audio or text information to a text- or speech-based emotion classifier that estimates sentiment and arousal levels. Server then combines these results into an emotional state representation, for example a vector indicating degrees of stress, anxiety, calmness, and confidence. Server stores this state together with a timestamp and context tags (for instance, current screen or task ID). The output of this step is an emotional state value associated with the current interaction.

### Step 9:

Server adjusts the prompt sentence or output parameters according to the emotional state.

Server receives as input the base prompt sentence and the emotional state from Step 8. If the emotional state indicates high stress, anxiety, fear, or overload, server modifies the prompt-generation rule to request shorter, more critical outputs, for example by adding phrases such as “Provide a concise checklist of the three most critical steps required today” or by specifying a maximum number of items. If the emotional state indicates calmness, confidence, or curiosity, server adjusts the prompt to invite more detailed explanations, such as “Include lessons learned and potential future risks.” Server may also set internal parameters like maximum output length and level-of-detail flags for post-processing. The output of this step is an adjusted prompt sentence or a configuration that will control how the generative AI model and subsequent modules operate.

### Step 10:

Server generates response information with the generative AI model.

Server receives as input the input information for the generative AI model from Step 6 and the adjusted prompt sentence or configuration from Step 9. Server feeds the tokenized representation of this input information into the encoder of the generative AI model and then runs the decoder to generate output tokens step by step. At each decoding step, server computes attention distributions over the encoded context and applies learned weight matrices to produce a probability distribution over the vocabulary, then selects the next token according to a decoding strategy such as greedy search or beam search. Server repeats this process until an end-of-sequence token is generated or a specified length limit is reached.

Server then detokenizes the generated tokens into natural language text. The output of this step is response information that may include work procedure descriptions, handover summaries, predicted problems, and recommended actions.

### Step 11:

Server structures and stores handover documents and work instructions.

Server receives as input the response information from Step 10. Server analyzes the response text to identify headings, bullet points, and key phrases indicating sections such as “Overview”, “Open Tasks”, “Risks”, and “Key Contacts.” Server uses this structure to build a hierarchical document representation containing sections and ordered items. Server may compute additional metadata such as risk scores by scanning for specific keywords or applying lightweight classifiers. Server then stores this structured document in a storage device and associates it with identifiers for the relevant worker, apparatus, and project. The output of this step is a structured handover document or work instruction record registered in persistent storage.

### Step 12:

Terminal presents the generated information to the user.

Terminal receives as input the structured document or work instruction record from Step 11.

Terminal renders section titles and items on a display in a layout that reflects priority and emotional considerations, such as placing critical safety warnings at the top. Terminal may also invoke a text-to-speech engine to convert selected sections into audio signals and play them through a speaker, which allows user to receive instructions while performing physical operations. Terminal logs which sections user opens, how long each section remains on-screen, and whether user requests more detail. The output of this step is a visual and/or auditory presentation of the generated content and an updated interaction history.

### Step 13:

Server adjusts work priority and assignment based on response information and worker state.

Server receives as input the response information from Step 10, work-related information from Step 1, and worker absence or load-state information from scheduling or monitoring subsystems. Server parses the response information to extract explicit recommendations, such as lists of tasks with suggested assignments or urgency levels. Server compares these recommendations with current assignments and load metrics to compute a new priority order for each task. Server then updates task records in the management system to reflect the new priority and, where appropriate, reassigns tasks to a different worker or to an automatic processing apparatus by issuing control or configuration messages. The output of this step is an updated set of task priorities and assignments stored in system data and, when applicable, control signals sent to apparatuses.

### Step 14:

Server generates continuation procedures when a worker is absent.

Server receives as input notification of worker absence and the updated task assignments from Step 13. Server identifies unfinished work items linked to the absent worker and constructs a continuation prompt sentence such as:

“Worker A is unavailable. Using the following list of open tasks and system states, propose a plan to continue these tasks automatically or reassign them. Prioritize tasks critical to operational continuity.”

Server then collects the necessary context (for example, open tasks and apparatus states) and forms input information for the generative AI model similar to Step 6. Server invokes the generative AI model to obtain detailed continuation procedures, including sequences of steps and suggested responsible entities. Server translates these recommendations into concrete instructions for substitute workers and control commands for automatic processing apparatuses and stores and/or dispatches them. The output of this step is a set of continuation procedures and associated instructions that maintain work progress despite the absence.

### Step 15:

User provides feedback on generated outputs.

User receives as input the presented handover documents, work instructions, and continuation procedures from terminal. User may edit text to correct inaccuracies, mark sections as helpful or unhelpful, or indicate that additional detail is required. User may also submit short comments describing missing elements or ambiguities. Terminal captures these edits and ratings as feedback information and transmits them to server. The output of this step is a set of user feedback records describing the perceived quality and adequacy of the generated content.

### Step 16:

Server updates prompt-generation rules and training data using feedback.

Server receives as input the feedback information from Step 15. Server analyzes which generated outputs received positive or negative evaluations, and which prompt patterns, lengths, and formats were associated with those outcomes. Server adjusts the generation rules of the prompt sentence, for example by modifying templates to include or exclude certain sections, changing default detail levels, or explicitly instructing the generative AI model to output in bullet-point form. Server also constructs new training examples by pairing original input information with user-edited outputs and adds these examples to the training dataset.

When appropriate, server fine-tunes the generative AI model using this updated training data, thereby aligning model behavior with user expectations and organizational practices. The output of this step is an updated set of generation rules and, in some cases, updated model parameters that improve the performance and efficiency of subsequent processing cycles.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

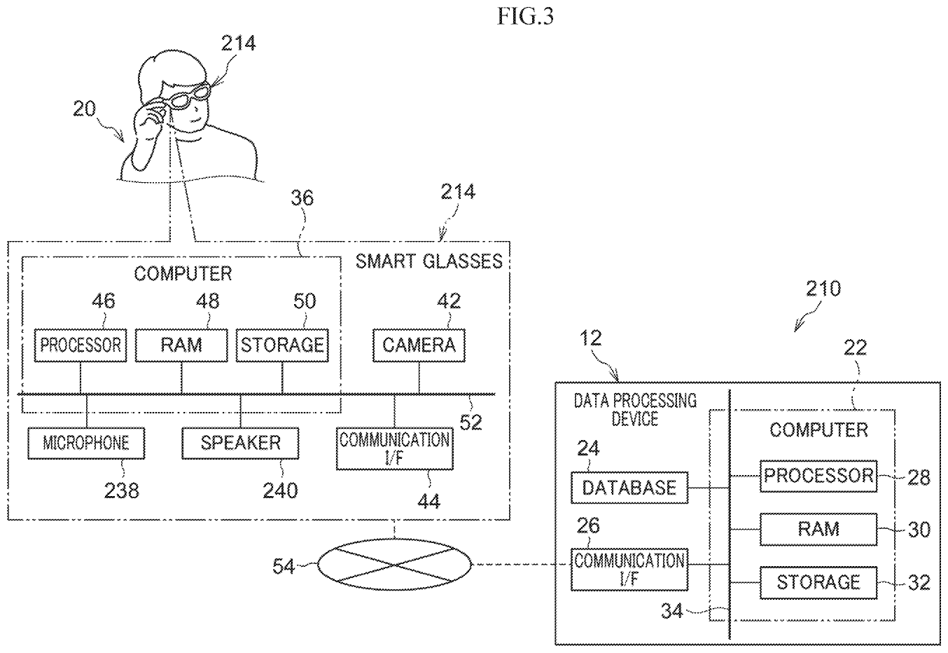

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

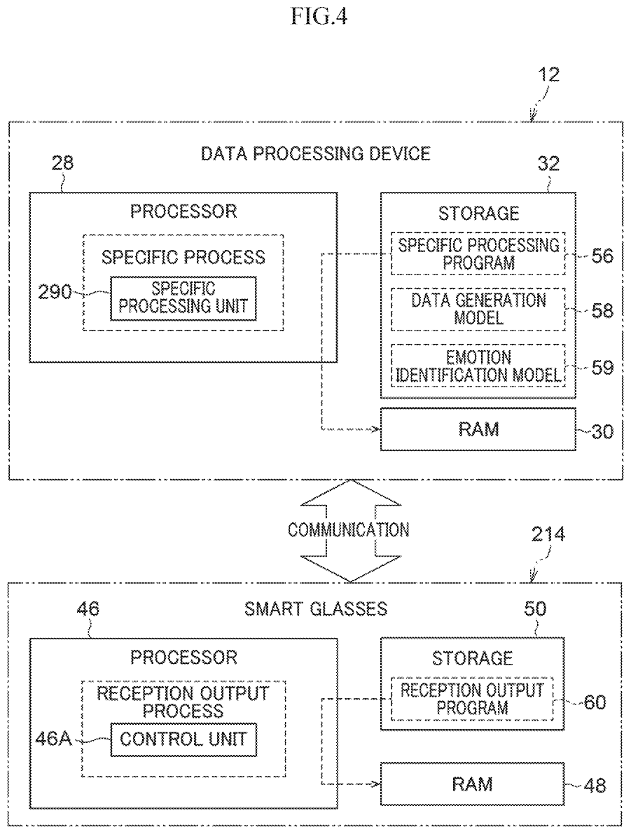

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

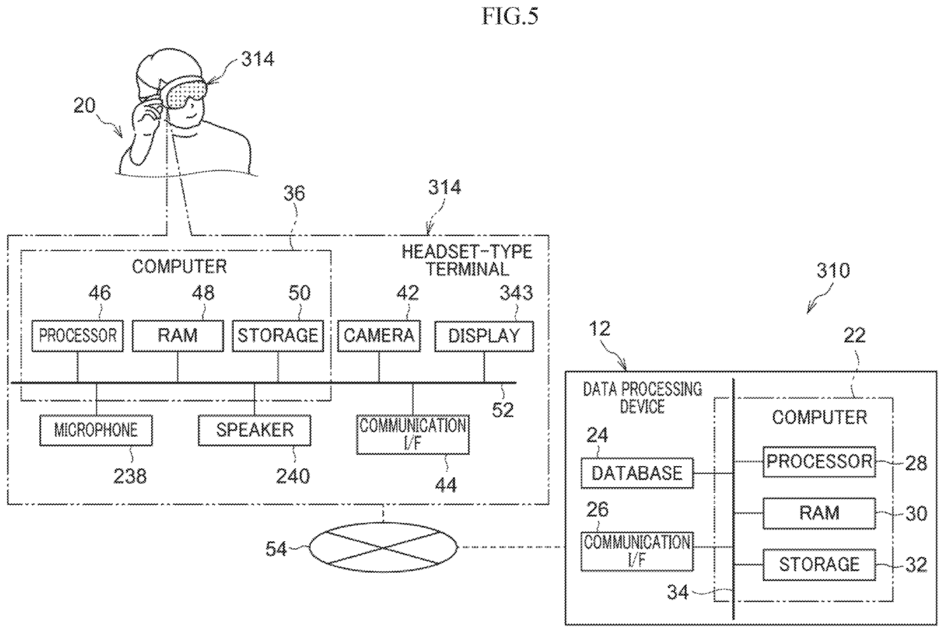

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

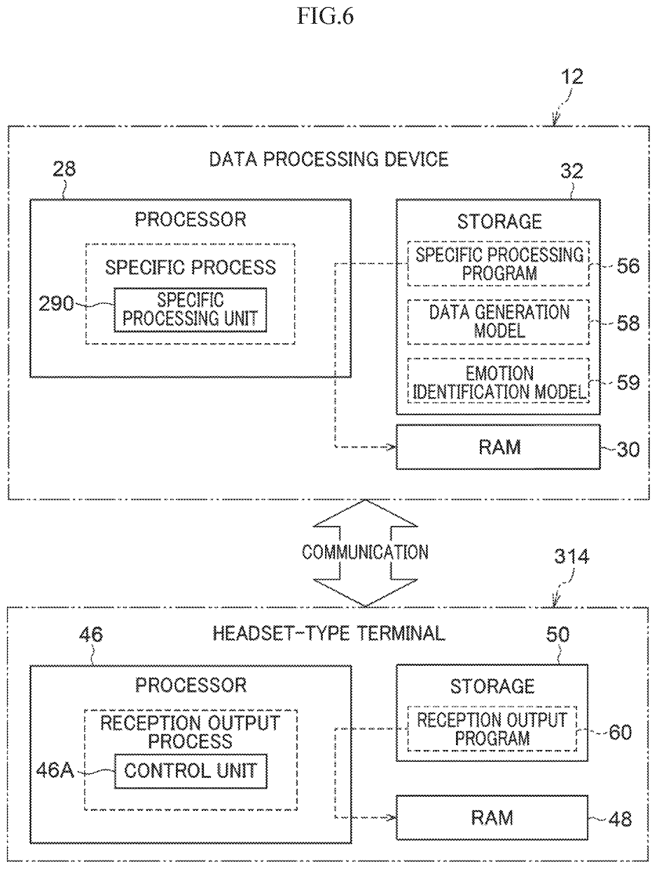

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

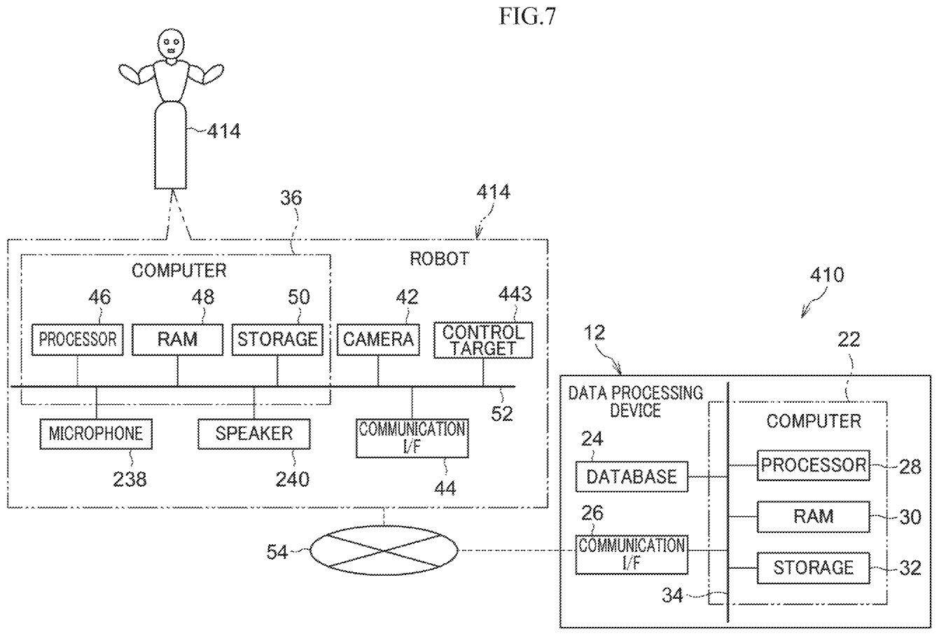

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

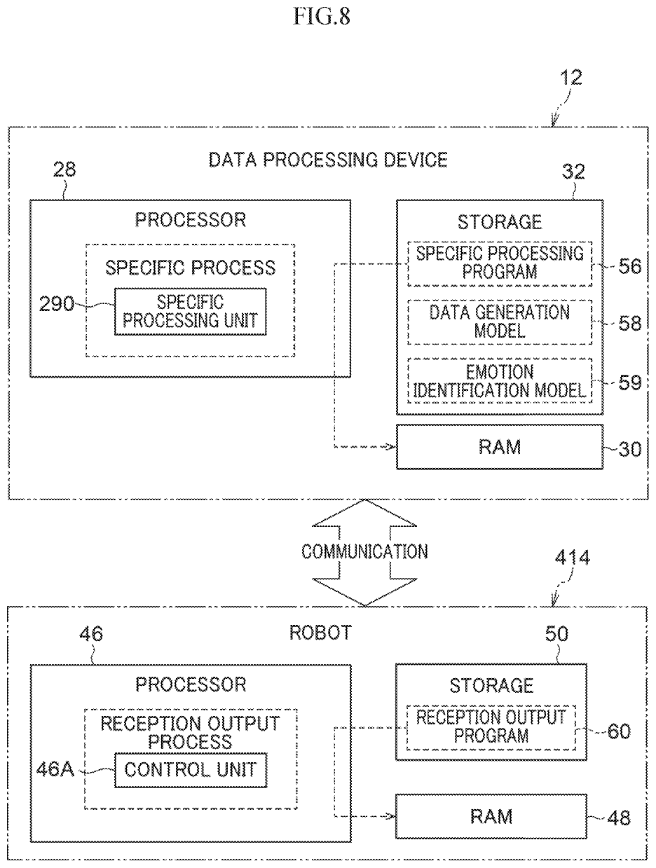

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

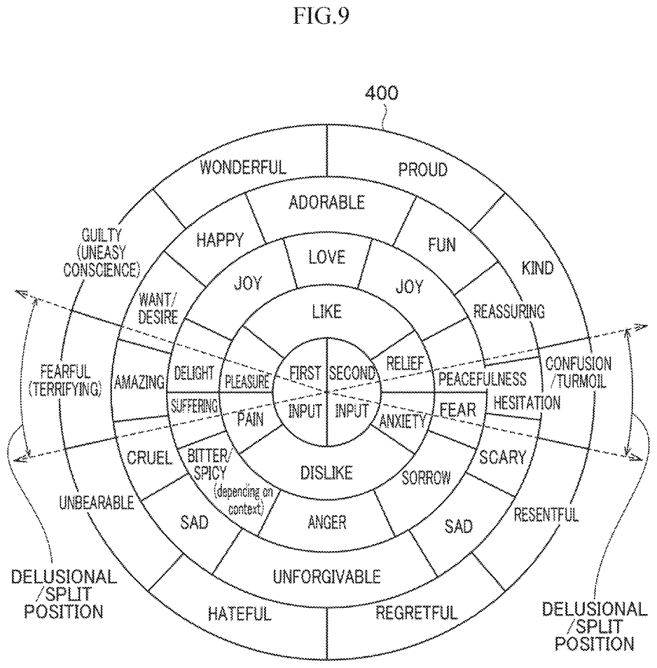

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University).

Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

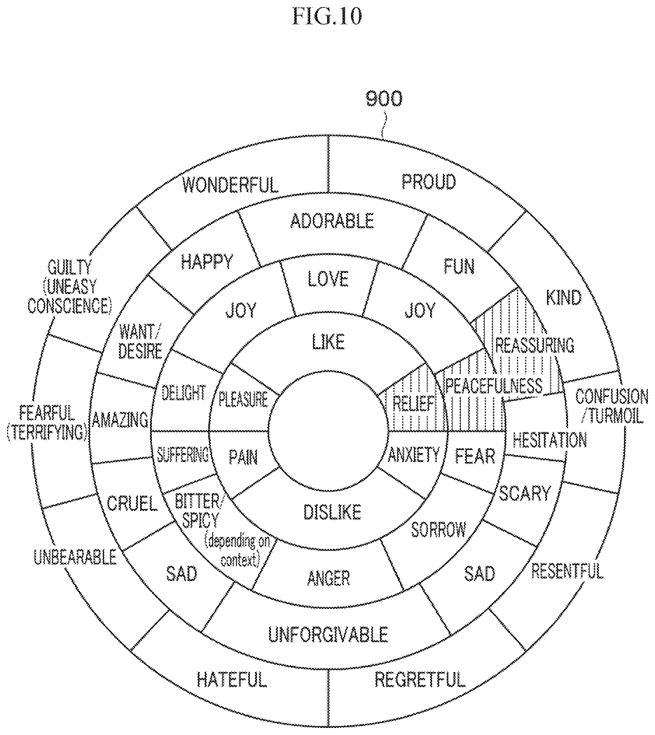

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (Saas).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor, a storage device, a communication interface, and a terminal device,
wherein the processor is configured to
acquire business information via the communication interface from the terminal device, normalize the business information into a predetermined format, and store the normalized business information in the storage device,
extract at least a part of the stored business information, structure the extracted business information by category, and generate an input data set for a generative AI model based on the structured business information,
generate a prompt sentence that instructs the generative AI model to analyze the input data set and to extract important information necessary for business handover, and input the prompt sentence and the input data set as model input to the generative AI model,
receive an analysis result output from the generative AI model, verify a format and content of the analysis result, reconstruct the analysis result as handover information classified into at least one section among a project progress section, a stakeholder section, a problem-and-solution section, an unresolved item section, a risk section, and a recommended action section, and store the handover information in the storage device in association with the business information,
transmit the handover information to the terminal device via the communication interface and cause the terminal device to visually display the handover information as a dashboard screen or a list screen,
acquire, from the terminal device, feedback information including at least one of evaluation information, correction information, and comment information with respect to the handover information, and store the feedback information in the storage device in association with the analysis result and the business information,
update, based on the feedback information, at least one of an extraction and structuring logic for the business information, a content of the prompt sentence to be supplied to the generative AI model, and a post-processing logic for an output of the generative AI model, so as to improve accuracy of generation of the handover information in a subsequent analysis, and determine an emotional state of a user by using an emotion recognition function and adjust at least one of display content and display order of the dashboard screen based on the emotional state so as to optimize a handover process and to reduce burden on the user and a successor.

### (Supplementary 2)

The system according to supplementary 1,
wherein the processor is configured to automatically generate the handover information at a time of retirement or reassignment of the user and to provide the handover information to a predecessor and the successor.

### (Supplementary 3)

The system according to supplementary 1,
wherein the processor is configured to analyze, in a cross-sectional manner, the business information related to a plurality of business fields within an organization, and to generate standardized handover information for securing continuity and substitutability of business operations in the organization by using the generative AI model and the prompt sentence.

### Application Example 1

### (Supplementary 1)

A system comprising a processor,
wherein the processor is configured to
collect work-related information from at least one information source,
store the collected work-related information in a storage structure,
acquire the work-related information stored in the storage structure and generate analysis data by performing preprocessing including completion of missing values, removal of outliers, and calculation of indicator values,
generate context information based on the generated analysis data and generate a prompt sentence that instructs a generative AI model to perform analysis of the work-related information and to generate handover information,
input the generated context information and the prompt sentence into the generative AI model and cause the generative AI model to generate, in natural language, the handover information and work improvement proposals,
format the generated handover information and the work improvement proposals in accordance with a predetermined item structure and store the formatted handover information and the formatted work improvement proposals in association with evidence information and generation condition information in the storage structure,
distribute the generated handover information and the generated work improvement proposals to an information terminal including a display device and cause the information terminal to display the handover information and the work improvement proposals in a format that is viewable by a worker,
acquire viewing status of the handover information by the worker and work-start status of the worker, and manage completion of a handover process based on the acquired viewing status and the acquired work-start status, and
accumulate the work-related information and an operation history of the worker as history information and ensure continuity and substitutability of work among different workers based on the history information.

### (Supplementary 2)

The system according to supplementary 1,
wherein the processor is configured to
treat, as at least a part of the work-related information, state information and operation information acquired from a detection device installed in a work apparatus,
generate the analysis data by calculating the indicator values including a production amount, a stop time, an inventory amount, and an abnormality occurrence status based on the state information and the operation information, and
include the indicator values in the prompt sentence.

### (Supplementary 3)

The system according to supplementary 1,
wherein the processor is configured to
cause the generated handover information to include completed tasks, uncompleted tasks, a status of materials, abnormalities relating to the work apparatus, and a recommended task order,
store the generated handover information as the history information in the storage structure, and
thereby realize effective handover in operation of work within an organization when a person in charge is changed due to retirement or reassignment.

### Example 2

### (Supplementary 1)

A system comprising a processor,
wherein the processor is configured to
obtain, from a storage device, work-related information and generate, based on the work-related information, an analysis target dataset that specifies a progress state of work and unexecuted work items,
generate, based on the analysis target dataset and instruction content input by a user, model input information including a prompt sentence to be input to a generative AI model, input the model input information to the generative AI model, and acquire, from the generative AI model, an analysis result indicating a current progress state of the work and work items to be executed next,
control, in correspondence with the work items included in the analysis result, a function of an external work support apparatus or work management apparatus to automatically execute at least one of schedule management, work registration, and notification transmission so as to execute the work in place of a human operator,
record, in the storage device as history information, content of the work executed in place of the human operator and the progress state of the work, and hold the history information as work history referable by a successor,
generate, based on the history information and the analysis result, summary information indicating a work outline for the successor and remaining work items, and output the summary information to a terminal device, and
adjust, based on emotion analysis performed by an emotion analysis unit configured to recognize an emotion of the user, at least one of content and timing of presentation of the prompt sentence and the summary information, so as to optimize a handover process and reduce a burden on the successor.

### (Supplementary 2)

The system according to supplementary 1,
wherein the processor is configured to
support handover at a time of change of a person in charge due to retirement or reassignment by automatically performing, by using the system, grasping of the progress state of the work, execution of the work in place of the human operator, and recording of the work history.

### (Supplementary 3)

The system according to supplementary 1,
wherein the processor is configured to
generate, in operation management of work within an organization, the prompt sentence based on the analysis result of the work-related information, and control the external work support apparatus based on an output of the generative AI model, thereby realizing effective handover while maintaining continuity and substitutability of the work even when the person in charge is changed.

### Application Example 2

### (Supplementary 1)

A system comprising a processor,
wherein the processor is configured to
acquire work-related information and preprocess the work-related information into training information,
build or update a generative AI model using a machine learning framework on the basis of the training information,
control a terminal device to generate a prompt sentence including a work procedure or a handover request to be input to the generative AI model, based on an operation history or a selection content of a user,
acquire related work information corresponding to the prompt sentence from an information storage device and append the related work information to the prompt sentence so as to create input information for the generative AI model,
input the input information for the generative AI model to the generative AI model and acquire response information including work procedure information or handover information from the generative AI model,
use an emotion engine that inputs user information or text information acquired from an imaging device and a sound acquisition device to an emotion analysis program or an emotion recognition service to specify an emotional state of the user, and adjust at least one of an information amount, a presentation order, and a detail level of the prompt sentence or the response information in accordance with the emotional state,
generate a handover document, work instruction information, or work support information on the basis of the response information and cause the terminal device to display or audibly output the handover document, the work instruction information, or the work support information,
reset a priority of work in accordance with an absence or a load state of a worker and determine work assignment or work continuation processing to an automatic processing apparatus or another worker by using the response information,
and update at least one of a generation rule of the prompt sentence and training data of the generative AI model on the basis of feedback information from the terminal device so as to continuously optimize a work handover process.

### (Supplementary 2)

The system according to supplementary 1,
wherein the processor is configured to automatically generate a continuation procedure for unfinished work of a worker on the basis of the input information for the generative AI model and an output of the emotion engine when the worker is changed due to retirement, transfer, or temporary absence, and to present handover instruction information for a substitute worker or an automatic processing apparatus to the terminal device.

### (Supplementary 3)

The system according to supplementary 1,
wherein the processor is configured to cause the generative AI model to predict a future problem event and a countermeasure procedure using history information and failure information generated in work operation, and, at a start of operation by a successor on the terminal device, to present the future problem event and the countermeasure procedure in a priority order determined in accordance with the emotional state of the user specified by the emotion engine.

What is claimed is:

1. A system comprising:
circuitry configured to:
receive, via a communication interface coupled to a packet-switched network, structured operational data from a terminal device, normalize the structured operational data into a machine-readable format, and store the normalized structured operational data in a storage device;
extract a subset of the stored structured operational data, categorize the extracted subset by data type, and generate an input dataset for a generative neural network model based on the categorized subset;
generate a prompt sentence specifying analysis instructions for the generative neural network model to identify information segments relevant to a continuity-transfer process, supply the prompt sentence and the input dataset to the generative neural network model, and receive an analysis result from the generative neural network model;
verify a format and content of the analysis result, reconstruct the verified analysis result as transfer-summary data classified into a plurality of sections, and store the transfer-summary data in the storage device in association with the structured operational data;
transmit the transfer-summary data to the terminal device for display; and
receive an emotion state parameter derived from user interaction data, and adjust at least one of a content ordering or presentation format of the transmitted transfer-summary data based on the emotion state parameter.

2. The system according to claim 1, wherein the circuitry is configured to apply a normalization algorithm to the received structured operational data to convert heterogeneous data formats into a uniform machine-readable schema, and store schema-conformant records in the storage device.

3. The system according to claim 2, wherein the circuitry is configured to apply a categorization algorithm to the stored schema-conformant records to assign each record to one of a plurality of data-type categories, construct the input dataset by aggregating records within each data-type category, and generate the prompt sentence by substituting the categorized data into a prompt template.

4. The system according to claim 3, wherein the circuitry is configured to classify the analysis result into at least one of a progress-status section, a relationship-data section, a problem-and-resolution section, an unresolved-item section, a risk section, and a recommended-action section, and store each classified section as a distinct record in the storage device.

5. The system according to claim 4, wherein the circuitry is configured to receive, from the terminal device, feedback data comprising at least one of evaluation data, correction data, or annotation data associated with the transfer-summary data, store the feedback data in the storage device in association with the analysis result and the structured operational data, and update at least one of an extraction logic, a prompt sentence content, or a post-processing logic based on the feedback data to improve accuracy of subsequent transfer-summary data generation.

6. The system according to claim 5, wherein the circuitry is configured to apply a closed-loop adaptation algorithm that selects updated extraction parameters based on accumulated feedback data, applies the updated extraction parameters in a subsequent execution of the categorization algorithm, and measures an improvement in a quality metric of the transfer-summary data after the update.

7. The system according to claim 1, wherein the circuitry is configured to apply an emotion recognition algorithm to user interaction data received from the terminal device to generate the emotion state parameter, classify the emotion state parameter into one of a plurality of emotional state categories, and select a dashboard layout and content ordering strategy based on the classified emotional state category.

8. The system according to claim 7, wherein the circuitry is configured to update the dashboard layout in response to a change in the emotion state parameter detected between consecutive interactions, regenerate the content ordering of the transfer-summary data sections based on the updated emotion state parameter, and transmit the regenerated ordering to the terminal device.

9. The system according to claim 1, wherein the circuitry is configured to generate a verification prompt sentence incorporating the analysis result and predefined quality criteria, input the verification prompt sentence to the generative neural network model, and receive a verification output indicating whether the analysis result satisfies the predefined quality criteria, and flag sections of the transfer-summary data that do not satisfy the quality criteria for human review.

10. The system according to claim 9, wherein the circuitry is configured to store flagged sections together with associated structured operational data in a review queue in the storage device, transmit the review queue to a designated terminal device, and receive correction data from the designated terminal device to update the flagged sections of the transfer-summary data.

11. The system according to claim 1, wherein the circuitry is configured to receive first attribute data comprising records describing ongoing project statuses and associated deadlines, second attribute data comprising records describing key relationships and contact information, and third attribute data comprising records describing unresolved items and associated risk levels, and incorporate the first attribute data, the second attribute data, and the third attribute data as sections of the input dataset.

12. The system according to claim 11, wherein the circuitry is configured to generate a risk-assessment prompt sentence incorporating the third attribute data specifying unresolved items and risk levels, input the risk-assessment prompt sentence to the generative neural network model to generate a risk-ranking output, and store the risk-ranking output as a risk section of the transfer-summary data.

13. The system according to claim 12, wherein the circuitry is configured to generate a recommended-action prompt sentence incorporating the risk-ranking output, input the recommended-action prompt sentence to the generative neural network model to generate a prioritized list of recommended actions, and store the prioritized list as a recommended-action section of the transfer-summary data.

14. The system according to claim 1, wherein the circuitry is configured to receive interaction log data recording prior exchanges between users and the terminal device, incorporate the interaction log data into the input dataset as a historical context section, and generate an extended prompt sentence that includes the historical context section as additional analysis conditions for the generative neural network model.

15. The system according to claim 14, wherein the circuitry is configured to apply an attention-based summarization model to the interaction log data to generate a compressed summary, substitute the compressed summary into the extended prompt sentence in place of the full interaction log data, and reduce input token length while preserving key interaction context.

16. The system according to claim 1, wherein the circuitry is configured to periodically retransmit updated transfer-summary data to the terminal device when stored structured operational data is updated, regenerate the prompt sentence incorporating the updated structured operational data, and supply the regenerated prompt sentence to the generative neural network model to produce an updated analysis result.

17. The system according to claim 1, wherein the circuitry is configured to generate a continuity-verification prompt sentence incorporating the transfer-summary data and a set of completeness criteria, input the continuity-verification prompt sentence to the generative neural network model to identify missing information segments, and generate a supplemental data request for transmission to the terminal device based on the identified missing information segments.

18. A system comprising:
circuitry configured to:
receive, via a communication interface coupled to a packet-switched network, structured operational data from a terminal device and store the structured operational data in a storage device;
categorize the stored structured operational data by data type using a categorization algorithm, generate a prompt sentence specifying analysis instructions for a generative neural network model, and supply the prompt sentence and categorized data to the generative neural network model;
receive an analysis result from the generative neural network model, classify the analysis result into a plurality of sections comprising a progress-status section, a relationship-data section, an unresolved-item section, a risk section, and a recommended-action section, and store the classified sections as transfer-summary data;
receive feedback data from the terminal device and update at least one of an extraction logic or a prompt sentence content based on the feedback data; and
apply an emotion recognition algorithm to user interaction data to generate an emotion state parameter, and adjust a content ordering of the transfer-summary data sections based on the emotion state parameter prior to transmission to the terminal device.

19. The system according to claim 18, wherein the circuitry is configured to generate a verification prompt sentence incorporating the transfer-summary data and predefined quality criteria, input the verification prompt sentence to the generative neural network model to identify sections that do not satisfy the quality criteria, and transmit a correction request for those sections to a designated terminal device.

20. A method performed by circuitry, the method comprising:
receiving, via a communication interface coupled to a packet-switched network, structured operational data from a terminal device, normalizing the structured operational data into a machine-readable format, and storing the normalized structured operational data in a storage device;
extracting a subset of the stored structured operational data, categorizing the extracted subset by data type, and generating an input dataset for a generative neural network model based on the categorized subset;
generating a prompt sentence specifying analysis instructions for the generative neural network model to identify information segments relevant to a continuity-transfer process, supplying the prompt sentence and the input dataset to the generative neural network model, and receiving an analysis result from the generative neural network model;
verifying a format and content of the analysis result, reconstructing the verified analysis result as transfer-summary data classified into a plurality of sections, and storing the transfer-summary data in the storage device in association with the structured operational data;
transmitting the transfer-summary data to the terminal device for display; and
receiving an emotion state parameter derived from user interaction data, and adjusting at least one of a content ordering or presentation format of the transmitted transfer-summary data based on the emotion state parameter.
